(19) United States
(12) Patent Application Publication
(10) Pub. No.: US 2003/0023353 A1
(43) Pub. Date: Jan. 30, 2003

(54) Arrangement for a switch-equipped steering wheel

(76) Inventor: Ziad Badarneh, Oslo (NO)

Correspondence Address: Rodman & Rodman, 7 South Broadway, White Plains, NY, 10601, US

(21) Appl. No.: 10/204,096

(22) PCT Filed: Feb. 16, 2001
(86) PCT No.: PCT/NO01/00056

(30) Foreign Application Priority Data
Feb. 18, 2000 (NO) 20000834
Jul. 12, 2000 (NO) 20003579
Oct. 11, 2000 (NO) 20005119

(51) Int. Cl. G06F 17/00

(52) U.S. Cl. 701/1

(57) ABSTRACT

At least two multifunction switches (82, 83) are mounted on opposite sides of a vehicle steering wheels (5) relative to it center to effect control of vehicle functions and/or optional functions. A display device (106) on the vehicle dashboard indicates available main functions (107b) and optional subsidiary functions thereof. A first (82) of the multifunction switches can be manipulated to effect selection of a main function and/or subsidiary function. A second (83) of the multifunction switches can be manipulated to effect initiation of selected control operation or function control (108f), and/or subsidiary control operation thereof. A person operating the switches can interactively control them by observing displays (107b; 108f) on the display device (106).

The present invention relates to an arrangement for a switch-equipped steering wheel in a vehicle, as for instance a car, where at least one function switch is provided to control associated vehicle-related or vehicle accessory-related function. More specifically, the invention relates to an arrangement, as disclosed in the preambles of attached independent claims 1, 2, 12 and 24.

Thus, the present invention relates to the use of one or more types of function switches that are implemented in a steering wheel or similar steering means for use in an automobile or other craft on land, at sea or in space which require a human driver, As the description and the claims are related to a vehicle in general, it should be understood that the invention is useful for use in any type of vehicle or craft.

Furthermore, the present invention relates to an interactive system for the use of a switch device mounted on a steering wheel in a vehicle, for example, a car, where the switch device is directly or indirectly arranged to operate or control vehicle functions and/or optional functions as disclosed in the preambles of attached, independent claims 33 and 47.

As is generally known in connection with the operation of vehicle functions and/or optional functions, the operating means for the vehicle functions and/or optional functions are spread across a large area of the vehicle dashboard, and often the operating means are either not positioned systematically or not sufficiently well marked, or are difficult to locate.

Accordingly, it is also an object of the present invention to provide an interactive system of the type referred to in the introduction where the operation of vehicle functions and/or optional functions is greatly simplified and made much more straightforward than is possible and also known today.

A driver of a modern car has a vast number of functions to think of, and at the same time an increasingly denser and more complex pattern of traffic to follow. The modern car has gradually become a high-technology unit equipped with advanced instruments related to comfort and safety, and which, as technology advances, will have optional functions implemented therein that are related to, for example, mobile telephones, the Internet, e-mail, TV/video, navigation, the display of maps etc. Therefore, there has also been a steady increase in the attention focussed on the conflict between the desire to use driving time efficiently for both driving and, for example, telephone calls, and at the same time the consideration of road safety.

Authorities all over the world are becoming increasingly concerned about road safety and especially how the use of mobile phones affects the driver in traffic. Today there is a so-called “hands-free” system for the use of mobile telephones in cars. This involves a microphone and a speaker being permanently mounted in the car with a connection to the mobile telephone that can unremovably or removably rest in a stand or may be permanently mounted in the car. A disadvantage of this system is that the driver must still use the keypad, for example, to call a subscriber. This means, often in addition to an installation of this kind of mobile telephone outside the normal field of vision the driver has when driving the car, that the driver must also deal with many buttons for the input of numbers, symbols and other data in the telephone. Mobile telephones have also gradually become so small that to strike the right key requires considerable precision. This problem has not been solved although it is possible to use voice-operated commands for certain types of mobile telephones. The last-mentioned technology is relatively new and still not in use in connection with motoring because in general there is too much noise around the driver. In any case, all systems must be capable of being operated without having to use sound, i.e., preferably a mechanical switch system.

The invention described in the present application teaches solutions that involve both mechanical and electronic switch solutions for mounting on a steering wheel and a means for signal transmission in this connection.

Today, some car manufacturers have simple switches mounted on the car steering wheel, but thus far these switches have had very limited use because they have only one pressure function per button. This means, for example, that one switch is designed to turn the volume of the car radio up or down, another to search for different stations, and another to search among functions such as radio, CD-player or wavebands.

Because of the need for a large number, these known switches will constitute a large volume, and therefore possible applications will be limited simply because there is not room for many switches on an ordinary steering wheel structure. Accordingly, it is an object of the invention to provide solutions which increase the scope for application of steering wheel mounted switch devices.

The device is based on the use of special multifunction switches that are mounted on the steering wheel The switches are preferably adjustable in order to satisfy the driver's requirements as regards ergonomics and use in order to enhance safety. The switches are designed to operate most of a car's normal functions, and also to control optional functions such as a mobile telephone, radio etc. The switches will preferably be made so that a car driver will no longer need to let go of the steering wheel in order to use them, the positioning on the steering wheel being such that the switches are within a natural distance for steering wheel grip, and given commands can be carried out, for example, by the use of a thumb on the driver's hands. Furthermore, the given commands can be displayed on a screen in the driver's field of vision.

The characteristic features of the inventive device and the interactive system are set forth in the patent claims and the accompanying sub-claims, and also in the description with reference to the figures.

Useful switch designs may, e.g., be one or more of the embodiments described in the Applicant's International Patent Application PCT/NO99/00373, although these embodiments should by no means be understood as limiting for the use of the present invention.

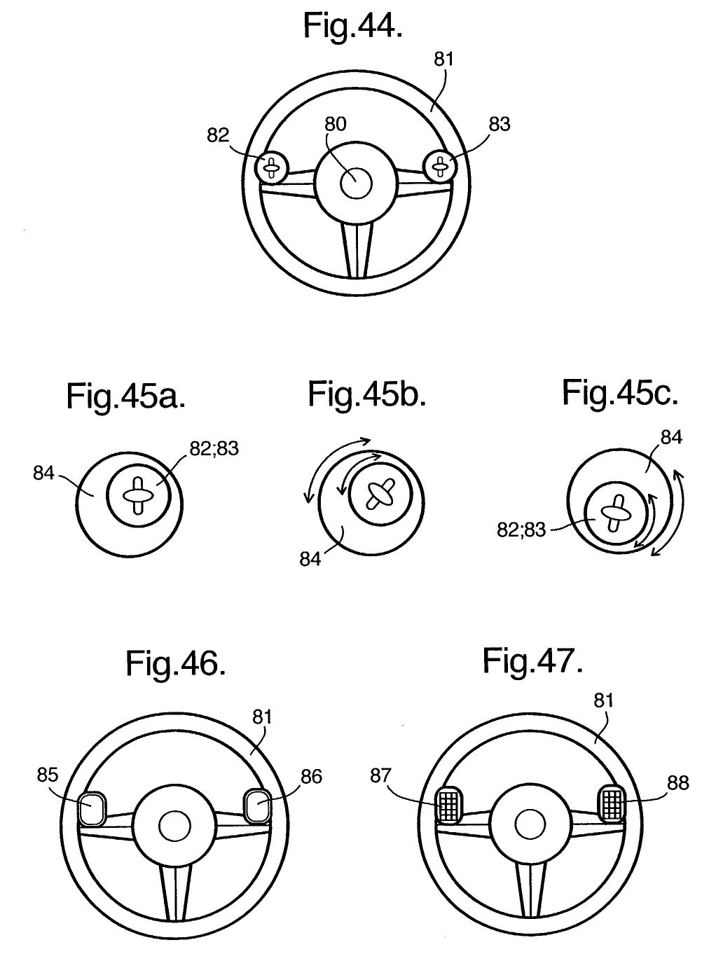

The description of the interactive system and the associated figures, FIGS. 44-109, show how functions may be efficiently operated in, for instance, a vehicle such as a car through the use of two sliding and pressure switches. In the illustrated case, although this is by no means limiting, the switches have four positions in the Y direction and three positions in the X direction. Sliding, pressure and tilting movements will give a total of twelve primary positions. In this connection, reference is made to, for example, FIGS. 10 and 14, and on the use of such multifunction switches, all information related to the manipulation of the switches will be shown in a display panel on the vehicle's dashboard. This means of course that it is also quite unnecessary to have to look at the multifunction switch whilst manipulating it.

The invention will now be described in more detail with reference to the attached figures.

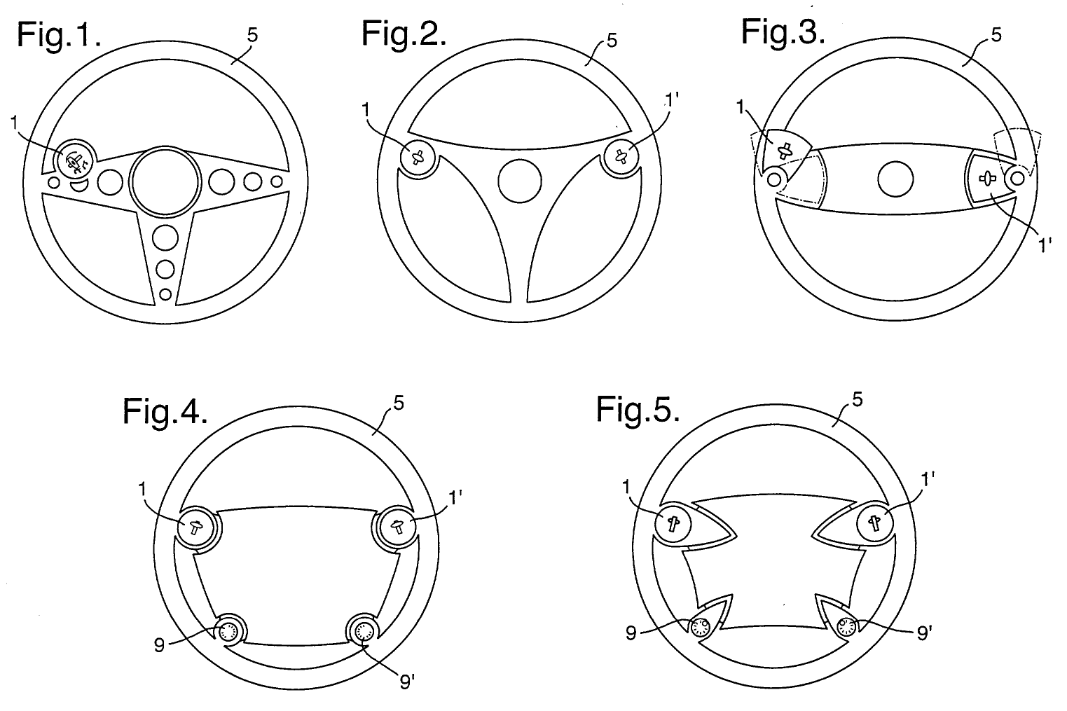

FIG. 1 shows a steering wheel equipped with a multifunction switch.

FIG. 2 shows a steering wheel equipped with two multifunction switches.

FIG. 3 shows a steering wheel equipped with two multifunction switches and having an alternative means of adjustment.

FIG. 4 shows a steering wheel equipped with two multifunction switches and two navigation switches.

FIG. 5 shows a steering wheel equipped with two multifunction switches and two navigation switches.

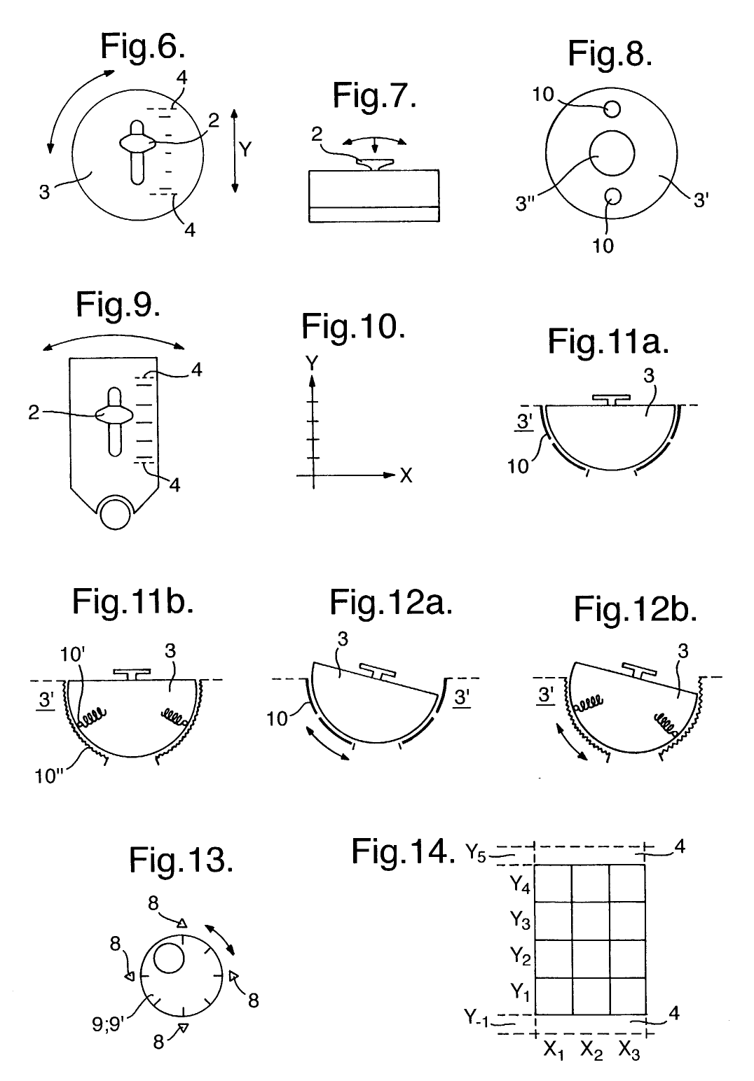

FIG. 6 is a horizontal view of the multifunction switch, see FIGS. 1, 2, 4 and 5.

FIG. 7 is a vertical view of the multifunction switch

FIG. 8 shows the multifunction switch from below

FIG. 9 shows a multifunction switch that is adjustable about an end point, see FIG. 3.

FIG. 10 illustrates typical x and y directions

FIG. 11 shows an alternative construction for adjusting the angle of the multifunction switch.

FIG. 12 shows the multifunction switch in an angled position.

FIG. 13 shows a rotatable navigation switch having four depression points.

FIG. 14 shows the positions a switch can have in relation to a coordinate system.

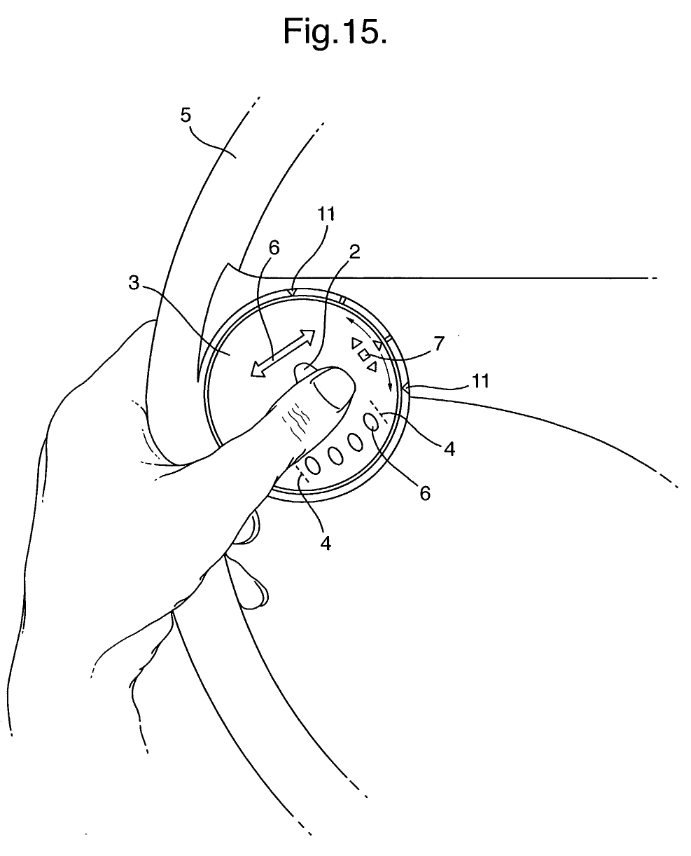

FIG. 15 shows how a multifunction switch according to the invention can be operated by the use of a thumb.

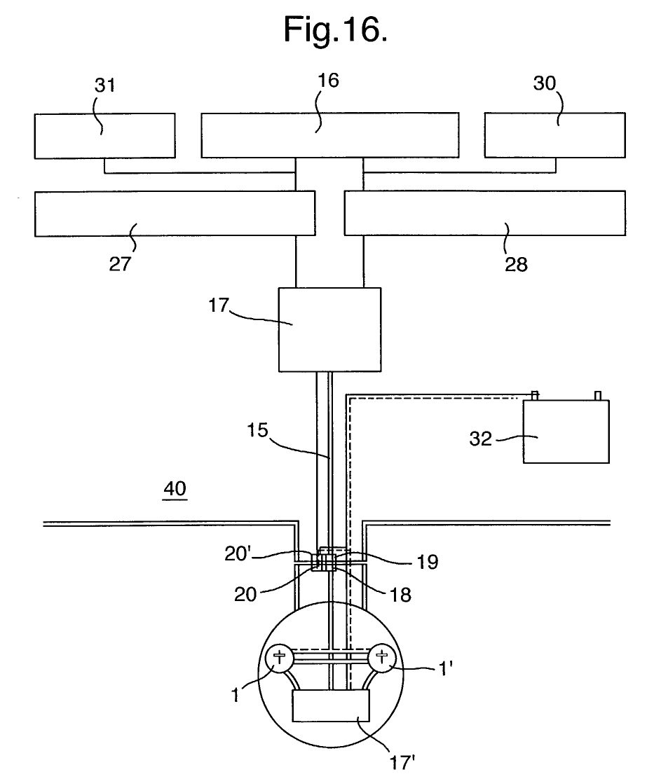

FIG. 16 is a schematic illustration of the connecting up of the device.

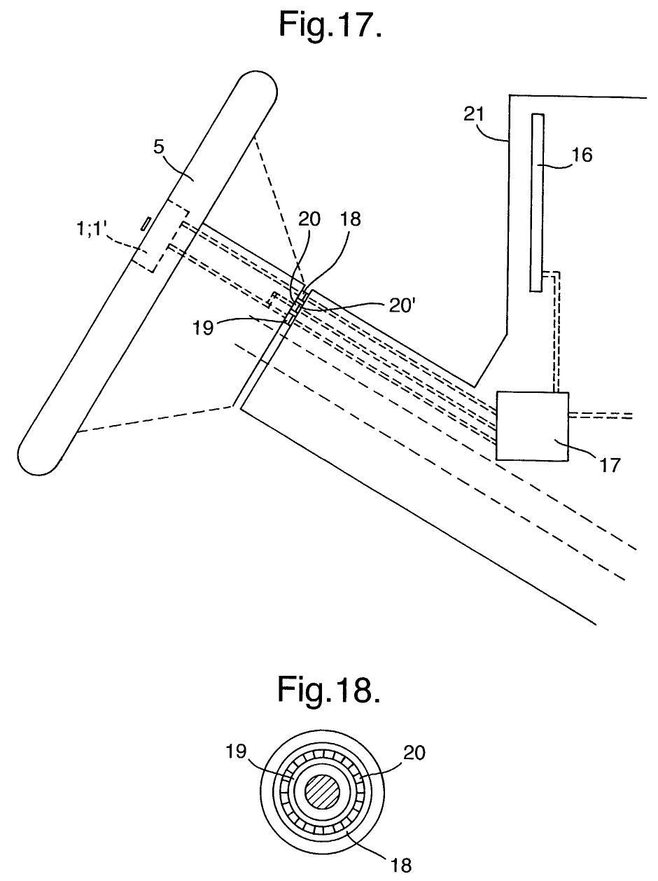

FIG. 17 is a schematic illustration of a steering wheel structure equipped with a multifunction switch, and shows how data is intended to be transferred via the steering column to the car components and a display

FIG. 18 shows a section through a steering column where connection for transfer of data and transmission of power is present. This figure also shows a dial that forms a detector for determining the turn of the steering wheel.

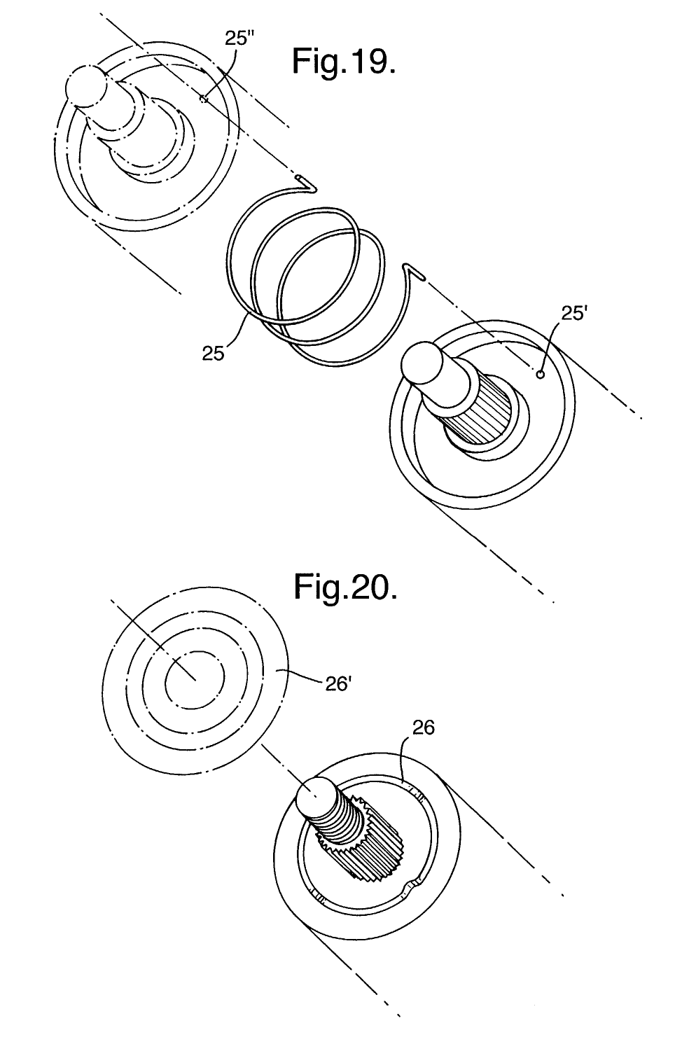

FIG. 19 shows a fixed power and data connection between the steering wheel and the steering column using a winding connection. For the sake of simplicity, the steering wheel is not shown in the figure.

FIG. 20 shows a fixed power and data connection between the steering wheel and the steering column using travelling or sliding contacts. For the sake of clarity, the steering wheel is not shown in the figure.

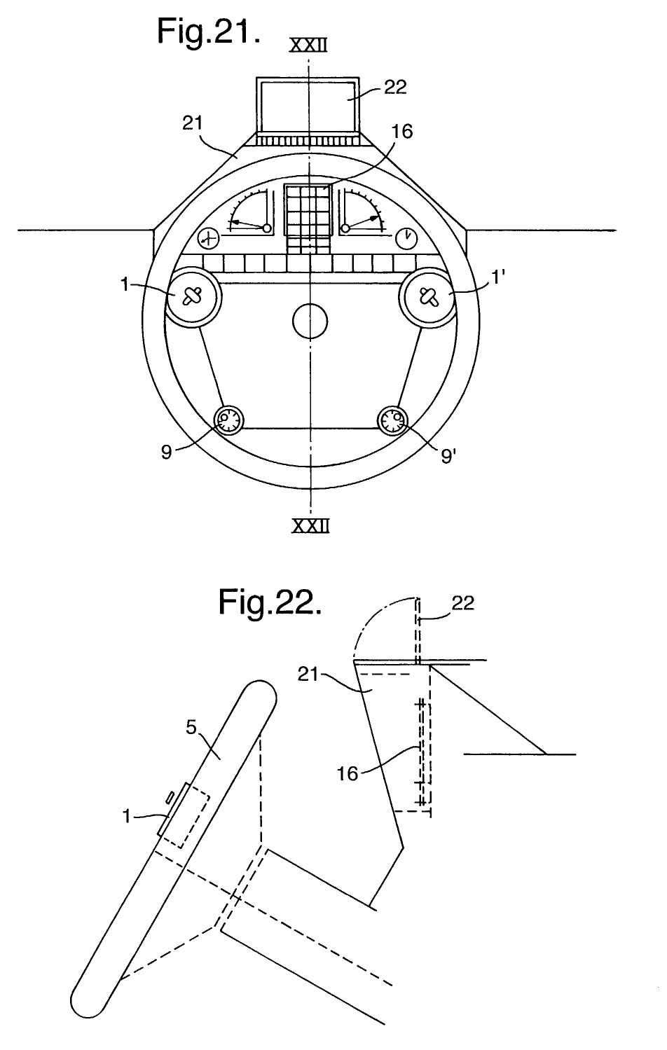

FIG. 21 is an illustration of a steering wheel and display/dashboard, and shows how the design could be implemented and how it functions together with the switches. An extra display above the dashboard is shown in opened state.

FIG. 22 is a vertical sectional view taken along the line XXII-XXII in FIG. 21.

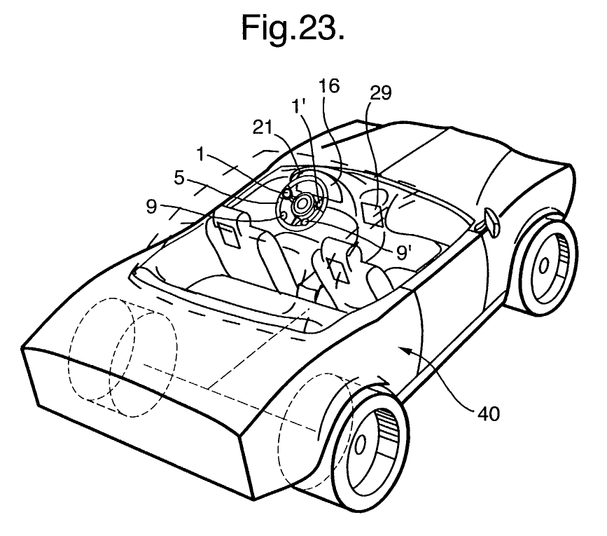

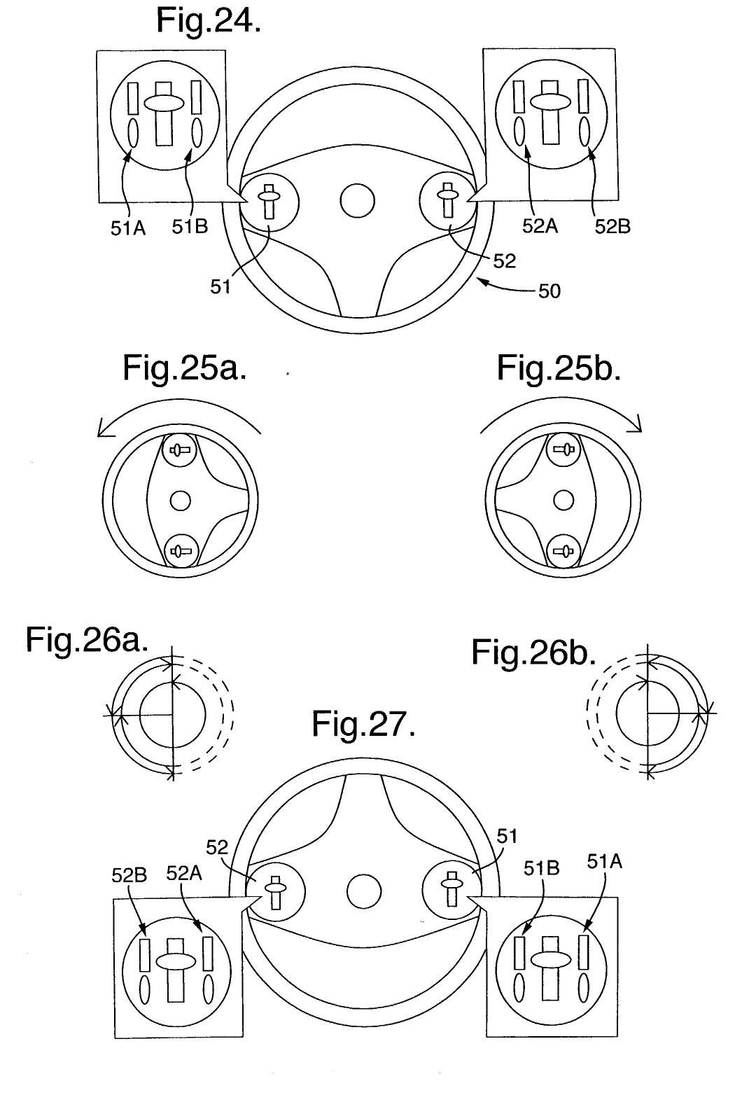

FIG. 23 is an illustration of a car in which the present arrangement has been implemented.

FIG. 24 shows a modified steering wheel equipped with two multifunction switches.

FIGS. 25a and 25b show the steering wheel in FIG. 4 turned 90° to the left and to the right respectively.

FIGS. 26a and 26b illustrate how the steering wheel in the positions shown in FIGS. 25a and 25b can be turned through an angle of 180°.

FIG. 27 shows the steering wheel solution shown in FIG. 24 turned 180° relative to the position shown in FIG. 24.

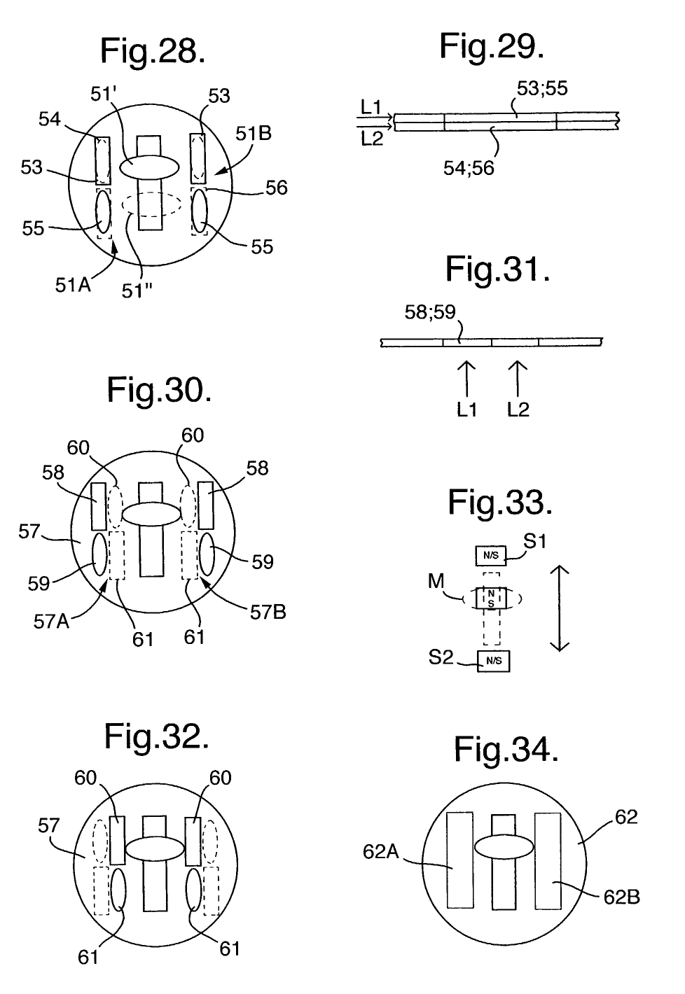

FIG. 28 shows details of a switch as indicated in FIGS. 24, 25 and 27; and FIG. 29 is a purely schematic illustration of the function marker configuration in FIG. 28.

FIG. 30 shows an alternative embodiment of the switch with function marker, whilst FIG. 31 is a purely schematic of the structure of such a marker.

FIG. 32 illustrates a change of the function markers on the switch embodiment according to FIG. 30 when the steering wheel has been turned through an angle of 180° relative to the normal position of the wheel.

FIG. 33 indicates a mechanism for desired adjustment of the switch control button in connection with an adjusted switch as is shown in FIG. 32.

FIG. 34 shows yet another embodiment of the switch provided with function marking.

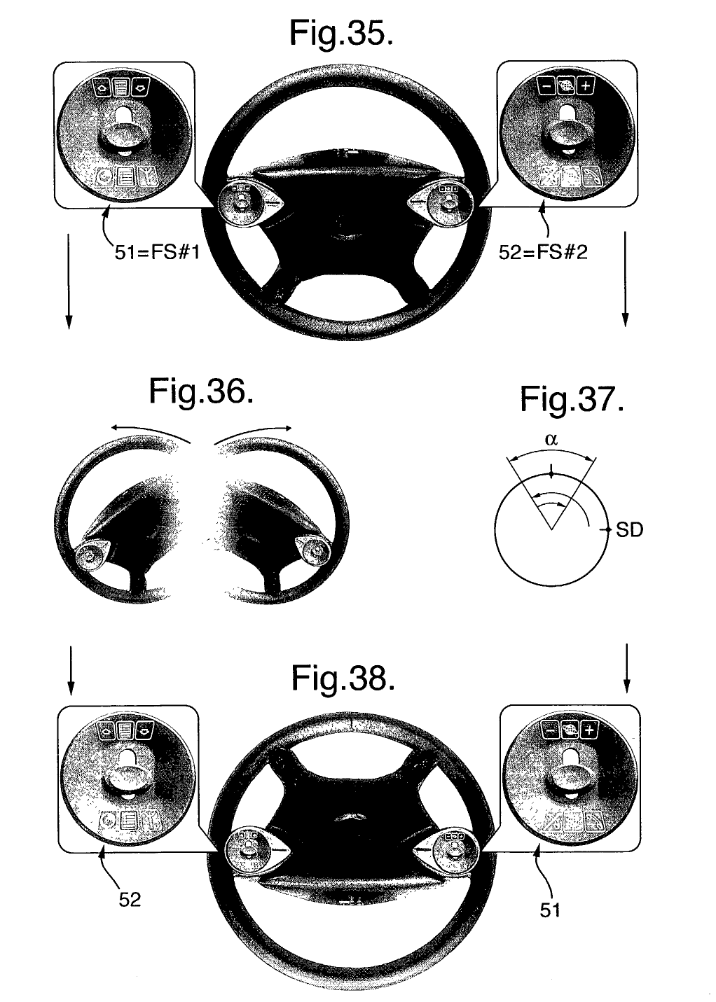

FIG. 35 shows in a more pictorial manner a practical embodiment of the device according to the invention.

FIG. 36 indicates two typical steering wheel positions where the function switches are about to become ineffective.

FIG. 37 indicates a typical angle range in which it may be required to allow the switch function to be inactive

FIG. 38 shows a switch configuration for the situation where the steering wheel has been turned 180° relative to a neutral position.

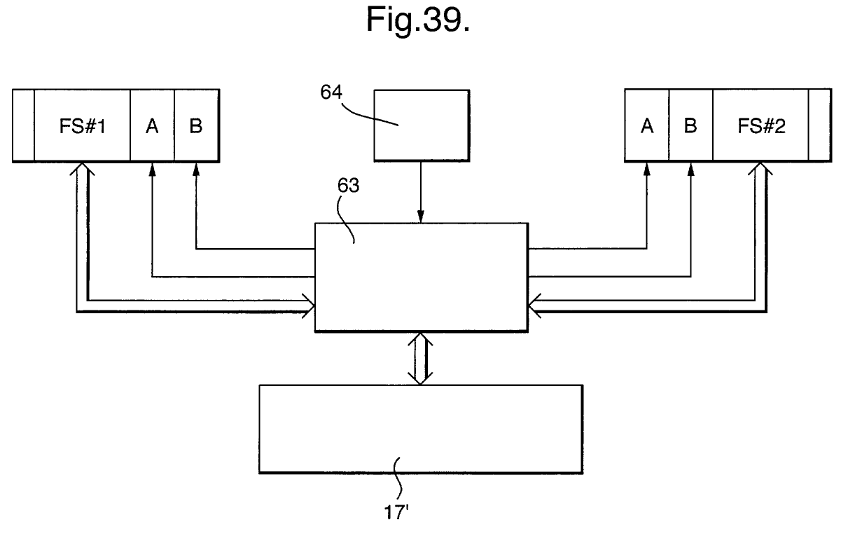

FIG. 39 is a simplified block diagram to explain the mode of operation of the arrangement

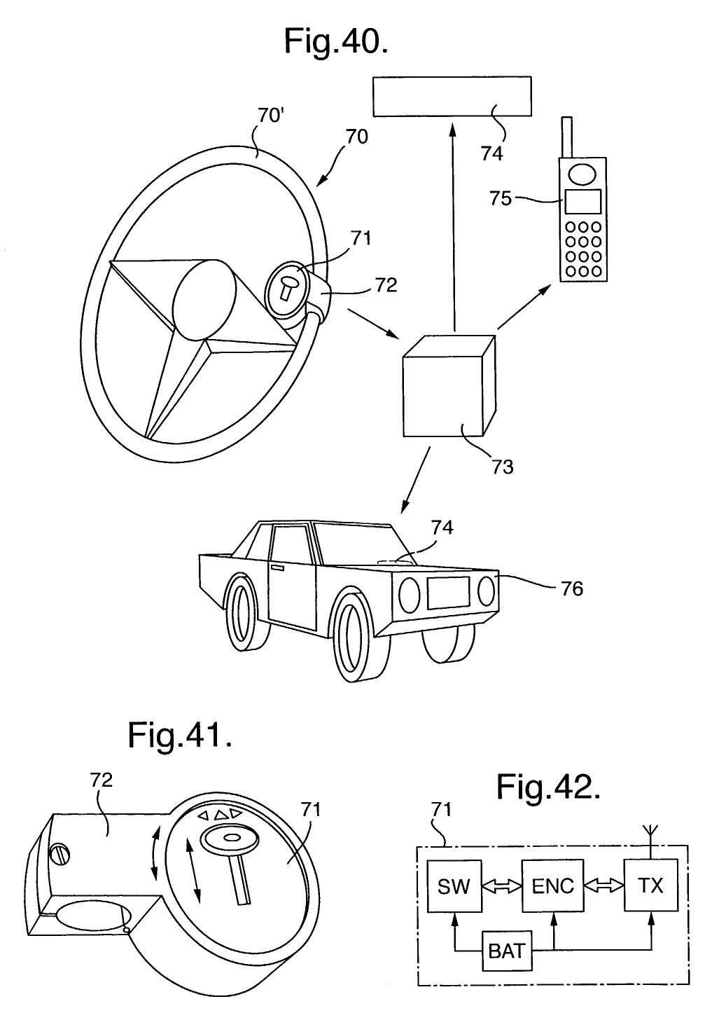

FIG. 40 shows another embodiment of the invention.

FIG. 41 shows a closer detail of the embodiment in FIG. 40.

FIG. 42 is a simplified block diagram of the device shown in FIG. 41.

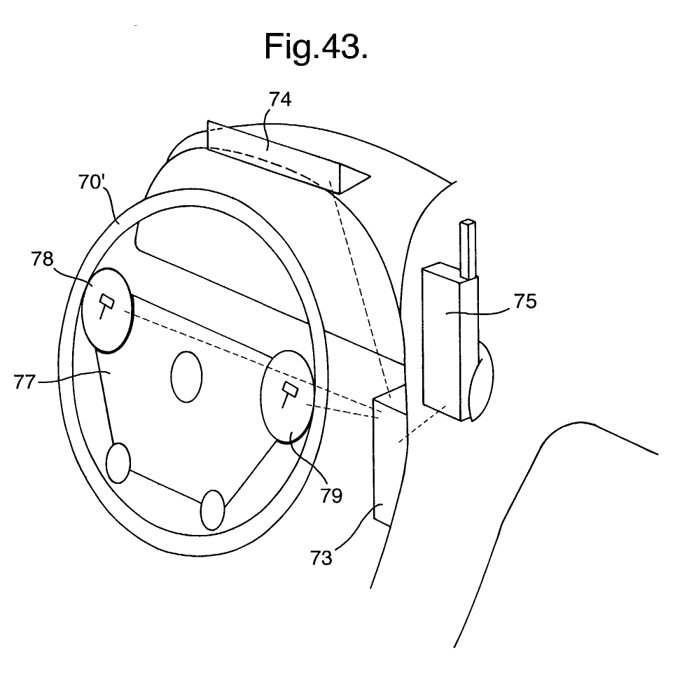

FIG. 43 shows a variant of the arrangement shown in FIG. 40.

The interactive system is shown and explained in more detail in connection with attached FIGS. 44-109.

FIG. 44 shows a steering wheel with two sliding, tilting and pressure-operated multifunction switches.

FIG. 45 shows a solution where the multifunction switch is mounted rotatably in a holder.

FIG. 46 shows an alternative embodiment of a steering wheel equipped with multifunction switches.

FIG. 47 shows another alternative of a steering wheel equipped with multifunction switches.

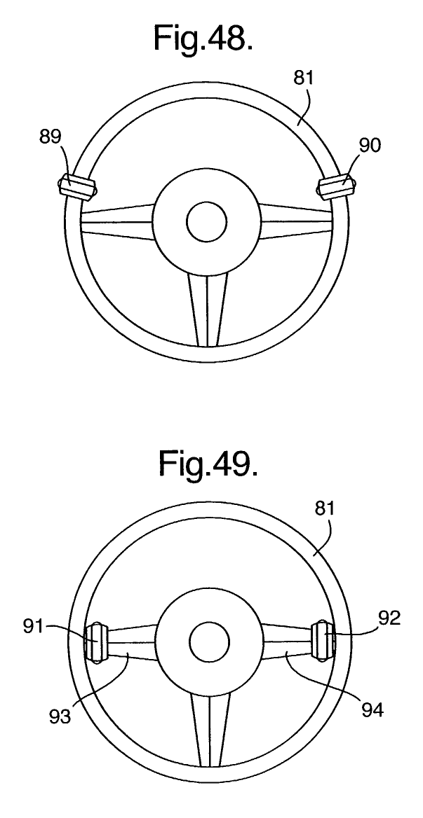

FIG. 48 shows yet another alternative embodiment of a steering wheel equipped with multifunction switches

FIG. 49 shows a modification of the solution shown in FIG. 48.

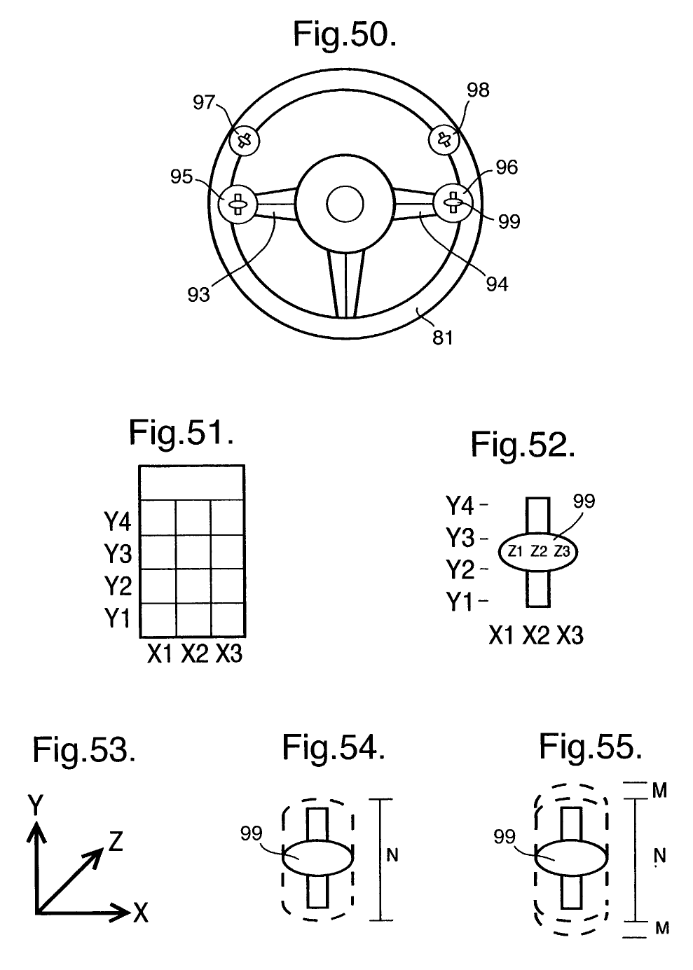

FIG. 50 shows a steering wheel equipped with four sliding, tilting and pressure-operated switches.

FIG. 51 defines a plane for the fields that will be described in connection with the steering wheel mounted switches.

FIG. 52 defines directions indicated by X, Y and Z for steering wheel mounted multifunction switches.

FIG. 53 defines X, Y and Z in this connection.

FIG. 54 shows a sliding, tilting and pressure-operated switch which in the chosen example has 4 Y positions.

FIG. 55 shows in part the same as FIG. 11, but with the addition of a possibility for so-called toggle operation at end positions.

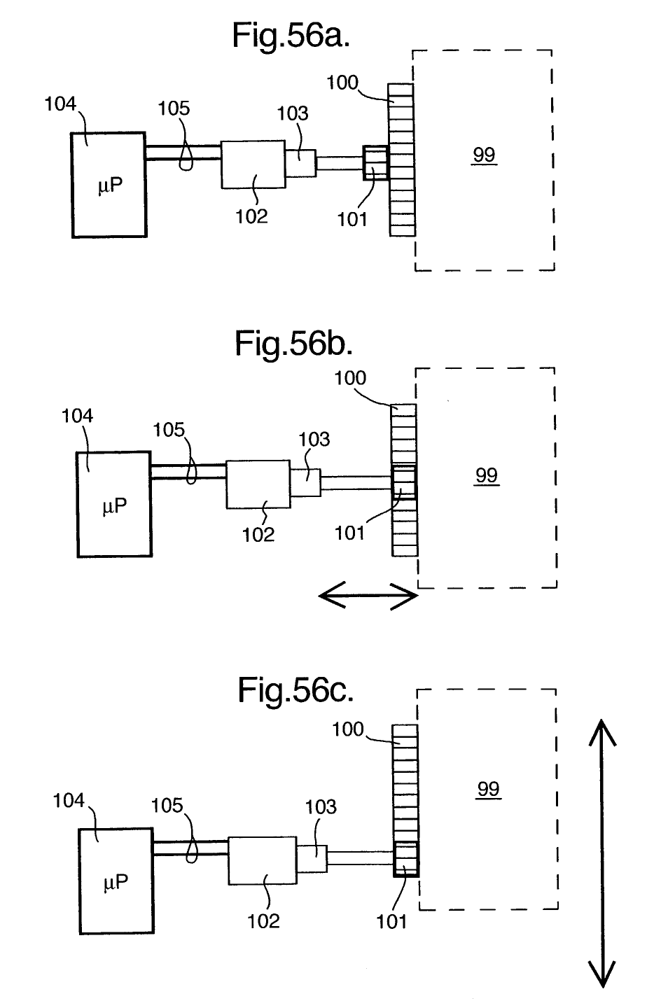

FIGS. 56a, 56b and 56c show a means for repositioning the control element on a sliding switch in connection with function change-over in a pair of multifunction switches on a substantial turn of the steering wheel, for example 90° relative to the normal position of the steering wheel.

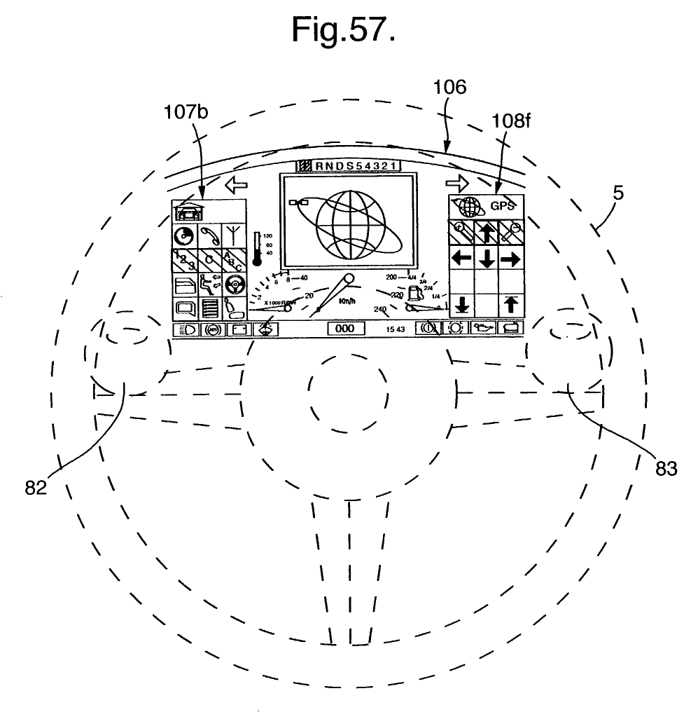

FIG. 57 shows a typical, but for the invention non-limiting embodiment of a display panel with display areas related to respective multifunction switches.

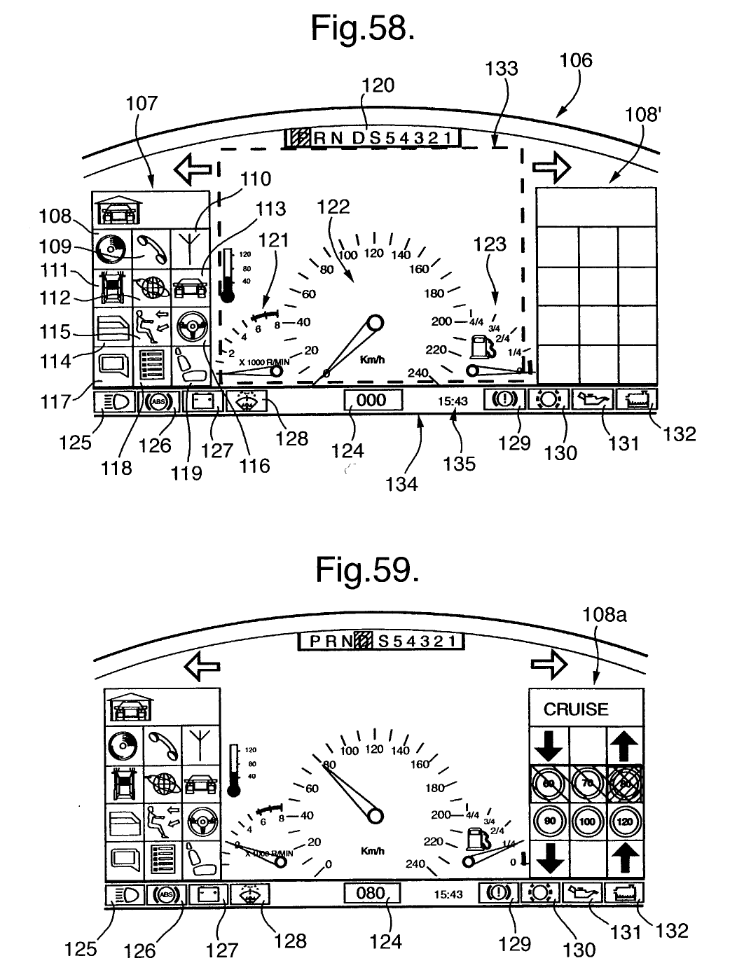

FIG. 58 shows a typical main menu in connection with the system

FIG. 59 shows a display screen image which may represent a neutral driving situation.

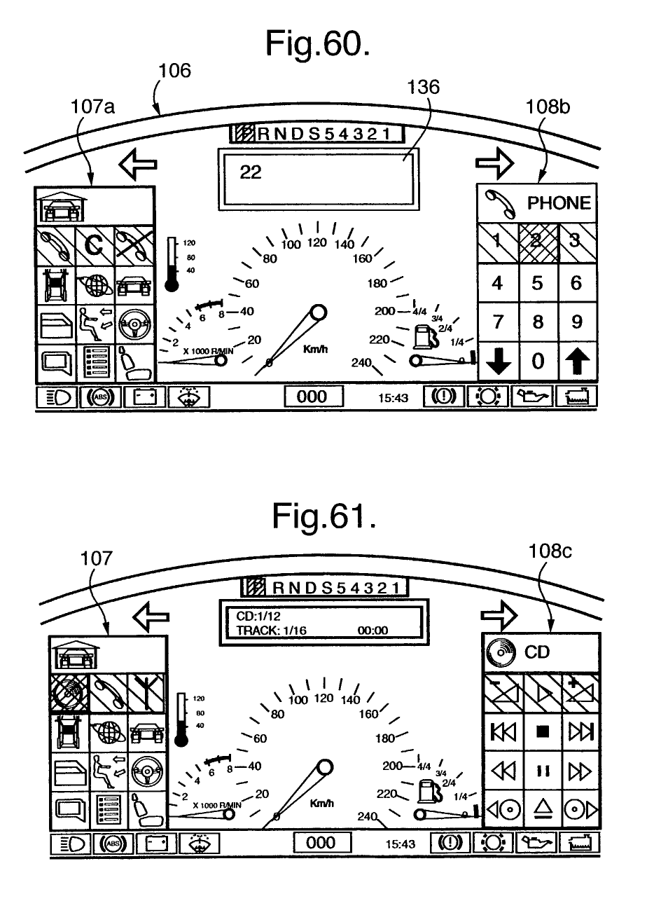

FIG. 60 shows a dashboard with a display screen in connection with a telephone function.

FIG. 61 shows a display screen, for example. in connection with the selection of CD-player.

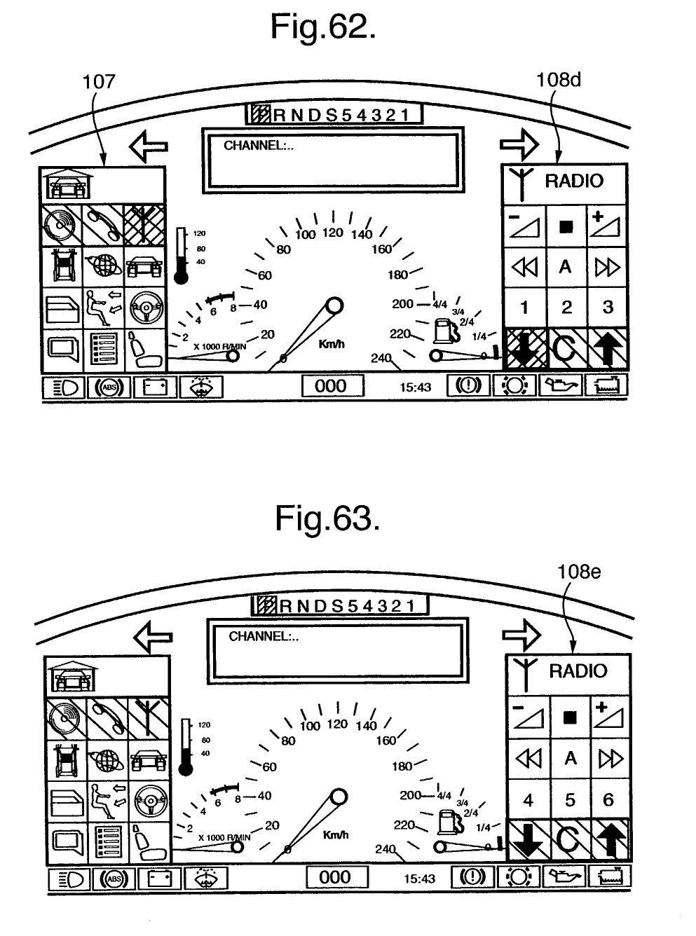

FIG. 62 shows a display screen in connection with the selection of radio, whilst FIG. 63 shows the option of radio channel selection.

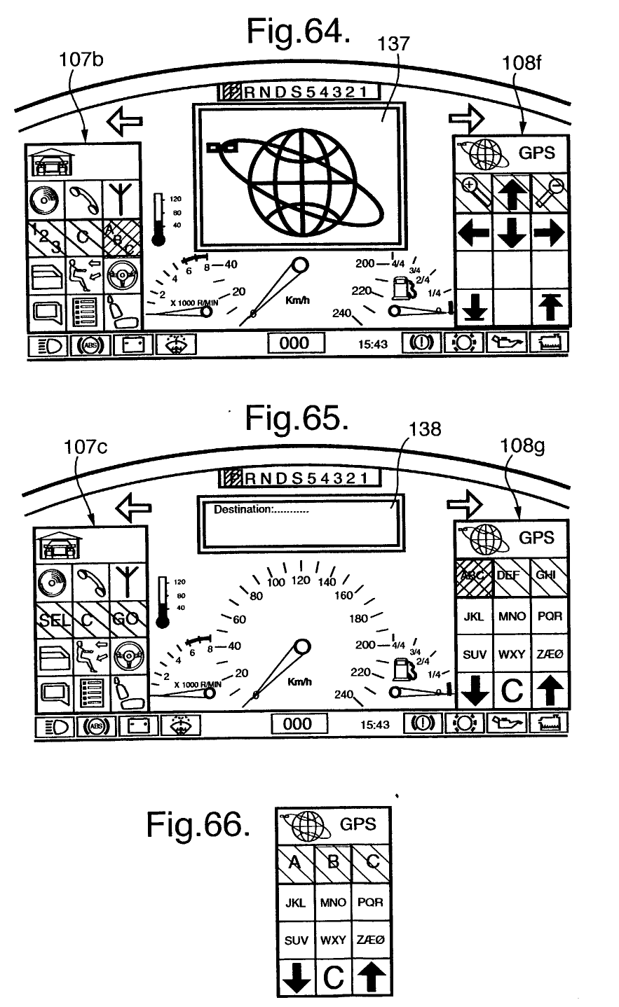

FIG. 64 shows a dashboard with a display screen in connection with the selection of GPS (Global Positioning System).

FIGS. 65 and 66 show in connection with GPS groups of letters of the alphabet, and where FIG. 66 shows additional splitting of a group of letters.

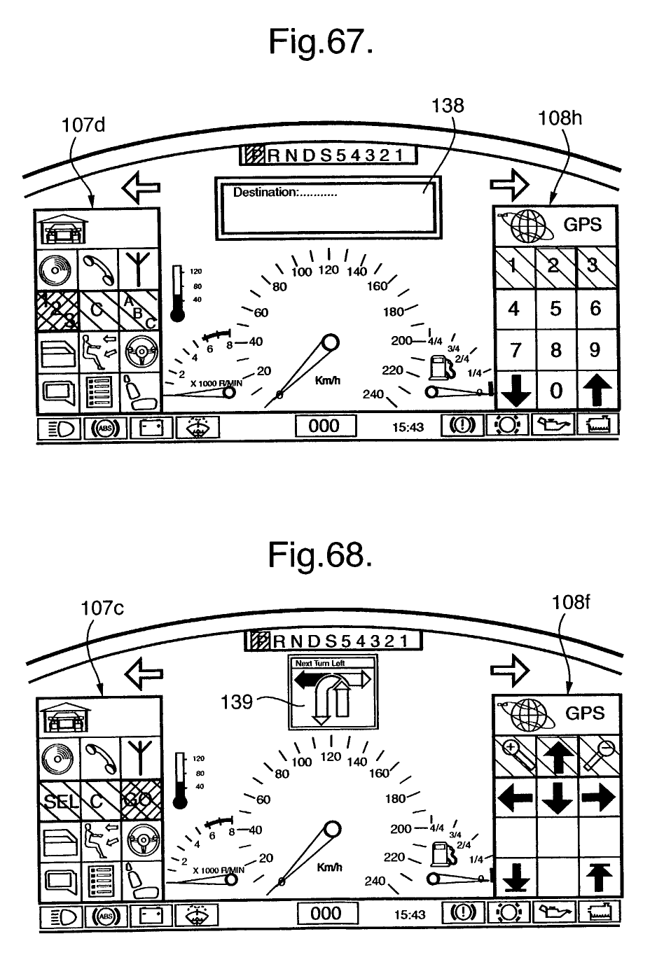

FIG. 67 shows what the right-hand area on a display screen may look like on the selection of numbers in the left-hand field.

FIG. 68 shows a change in the left-hand area and with accompanying display in the right-hand display area.

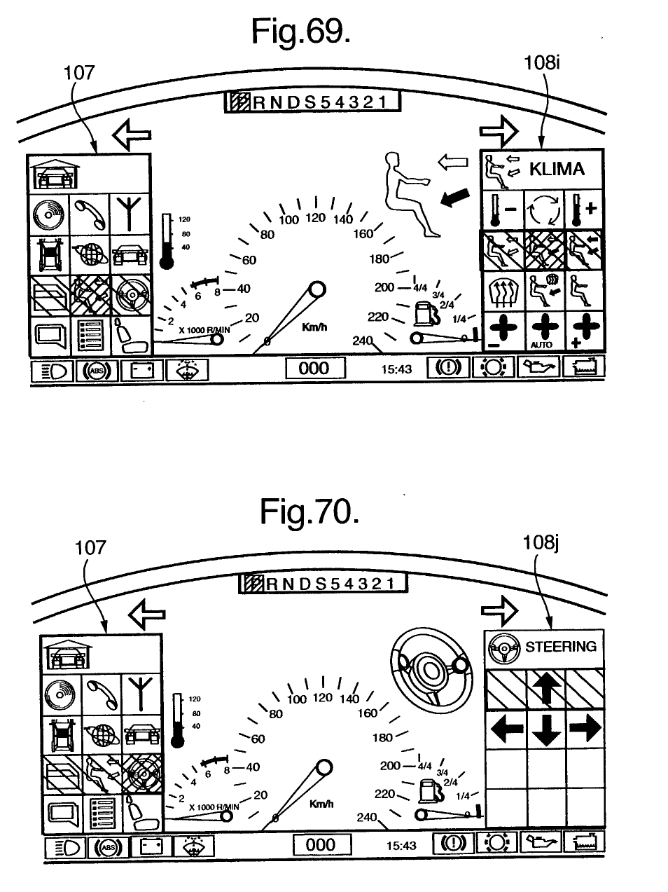

FIG. 69 shows the result of a selection in the left-hand field or area of options relating to the adjustment of the air conditioning system.

FIG. 70 is related to the adjustment of the steering wheel.

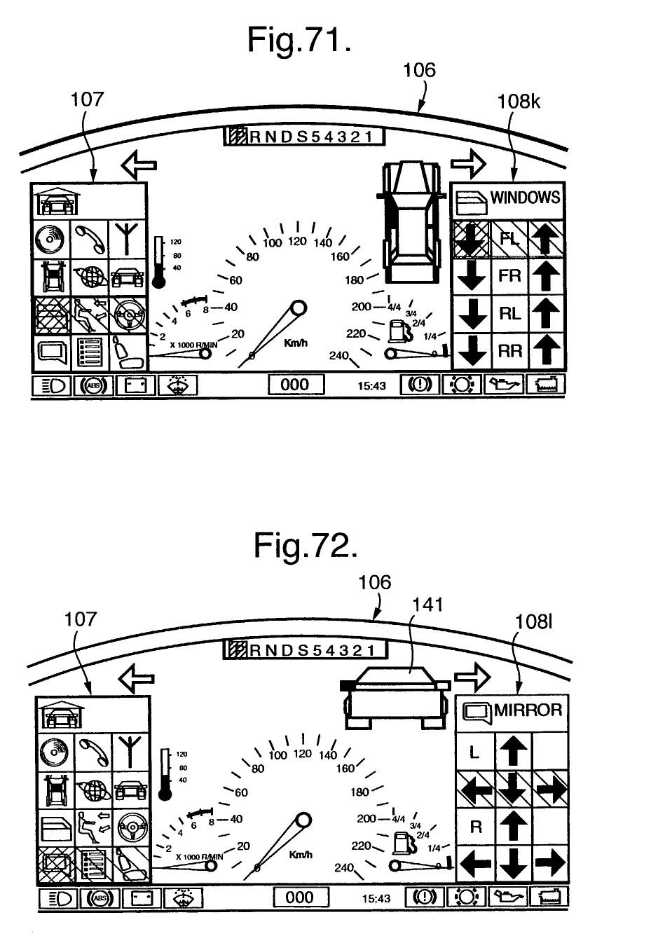

FIG. 71 is related to the operation of the vehicle's windows.

FIG. 72 is related to the control of the vehicle's wing mirrors.

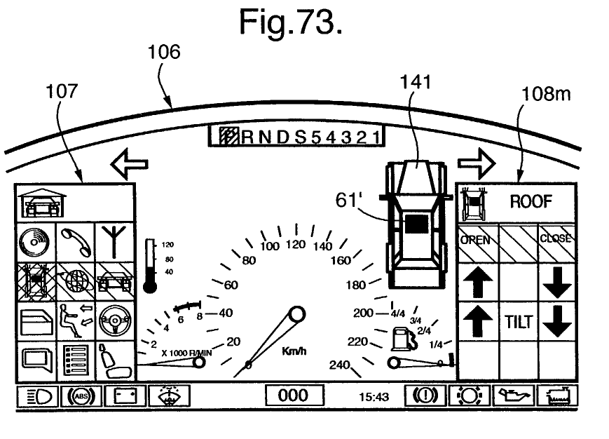

FIG. 73 is related to the control of the vehicle's sunroof, if the vehicle is equipped with one.

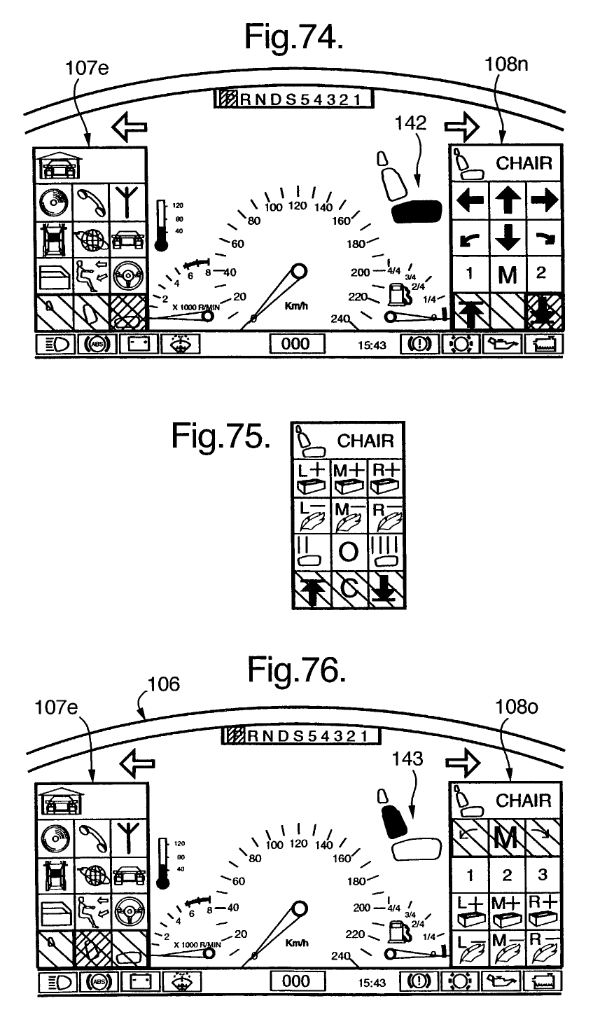

FIG. 74 is related to seat adjustment; and FIG. 75 shows possible adjustment of, for example, the firmness or softness of the seat.

FIG. 76 is related to seat back adjustment.

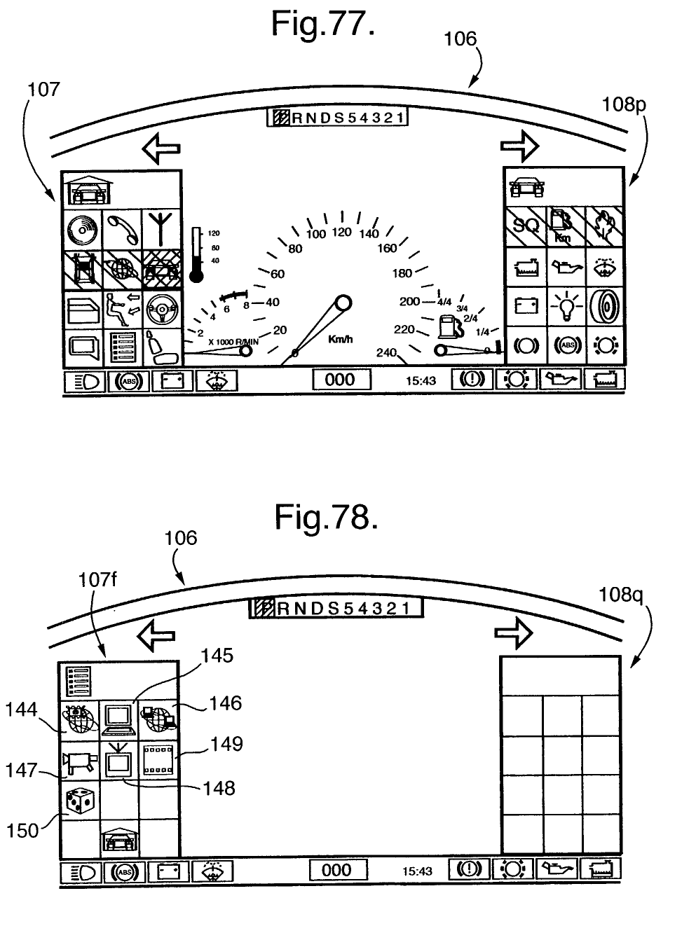

FIG. 77 is related to the on-board computer for the control of certain essential functions of the vehicle.

FIG. 78 shows what the display screen may look like if the user chooses to go into a sub-menu.

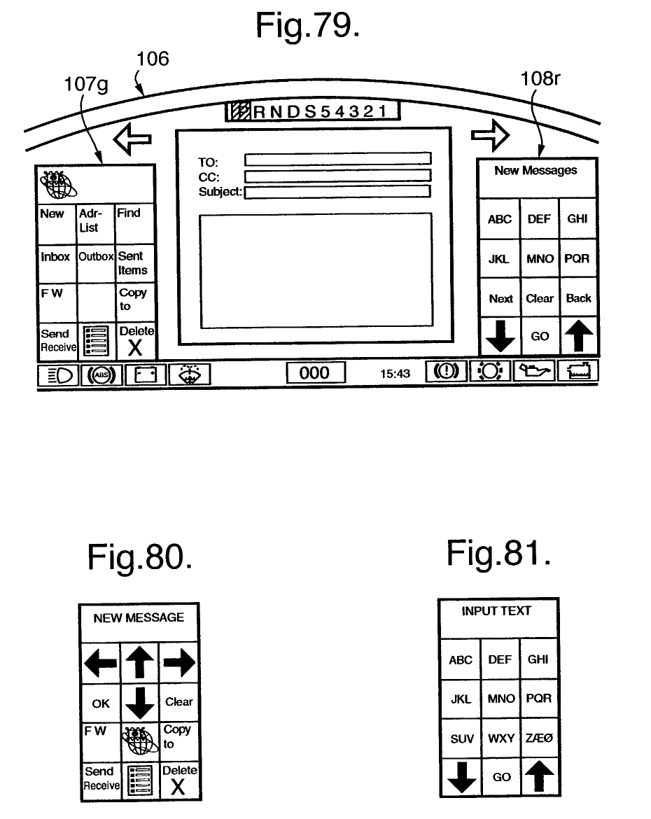

FIG. 79 shows what the display screen may look like in connection with the selection of, for example, e-mail.

FIG. 80 shows an alternative for the control of a cursor on the display screen

FIG. 81 shows letter input possibilities.

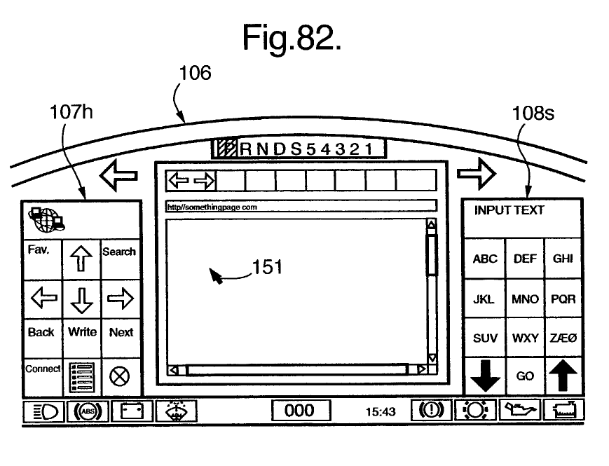

FIG. 82 shows a typical display screen in connection with selection of the Internet.

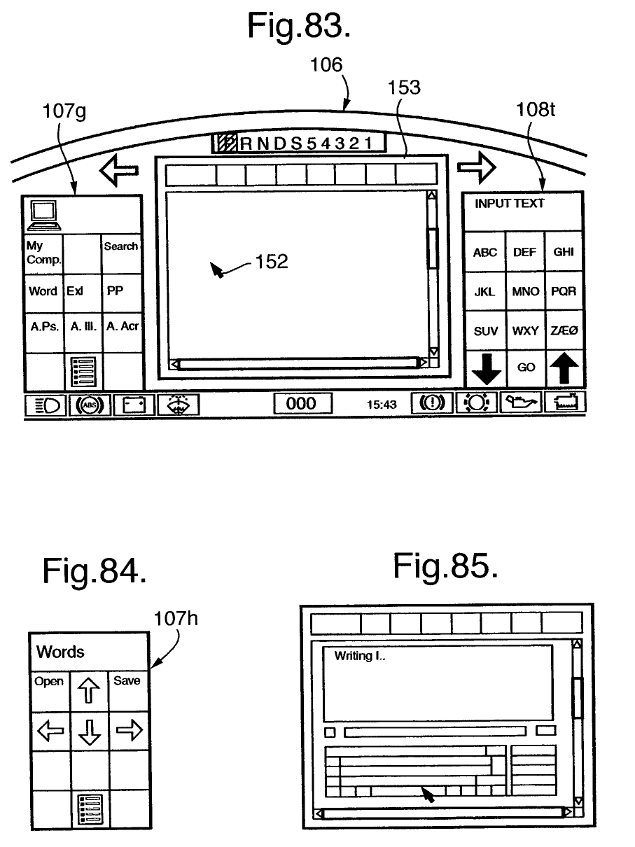

FIG. 83 shows a display panel in connection with selected function as computer.

FIG. 84 shows the possibility of cursor navigation; and FIG. 85 illustrates the possibility of text input.

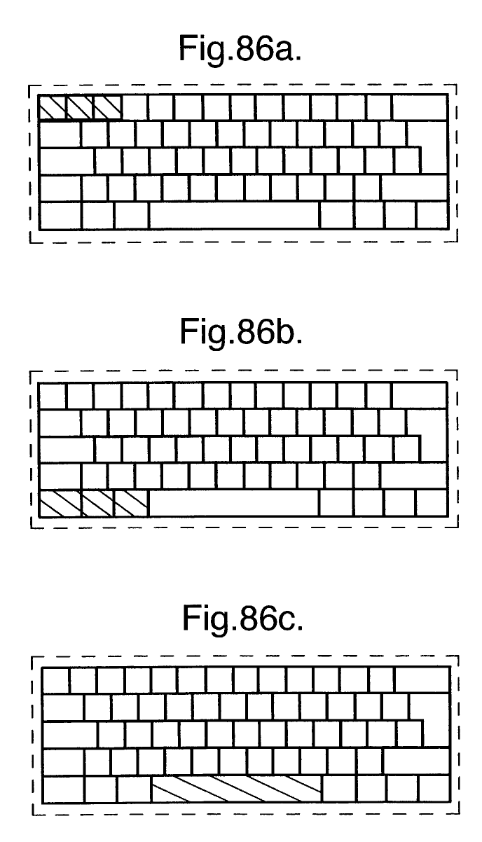

FIG. 86 shows a keyboard configuration that can be laid out on the display screen.

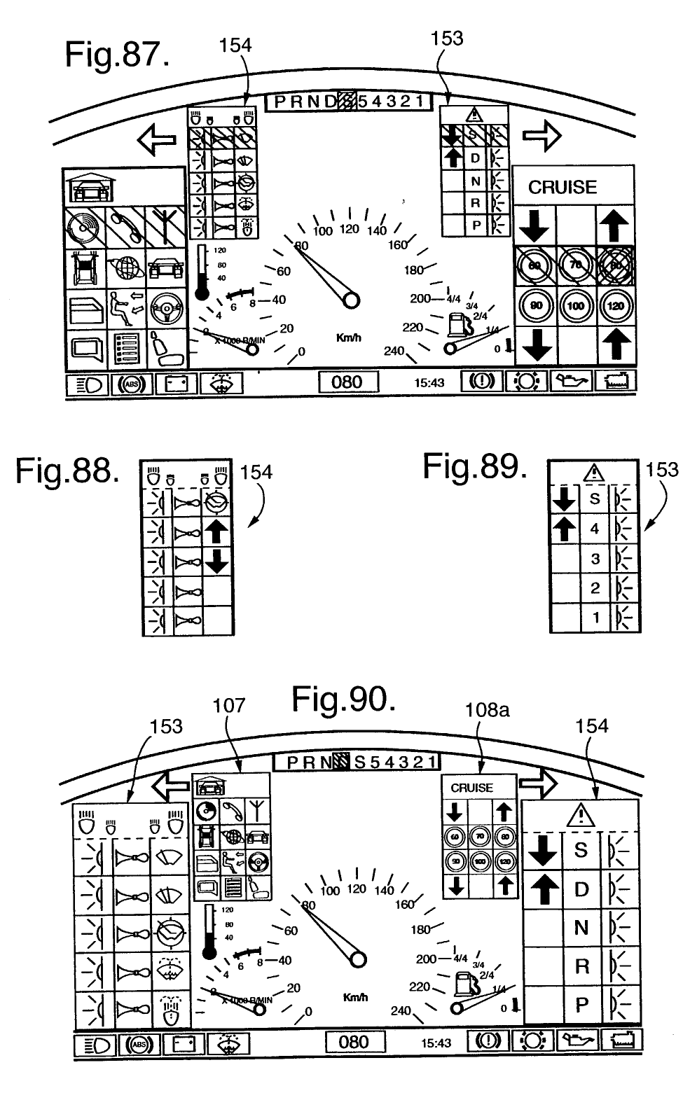

FIGS. 87, 88 and 89 show functions connected to multifunction switches that are to operate fast-reaction functions.

FIG. 90 shows a second, alternative screen image display to that shown in FIG. 87

FIG. 91 shows how possible passengers in a vehicle can use the system.

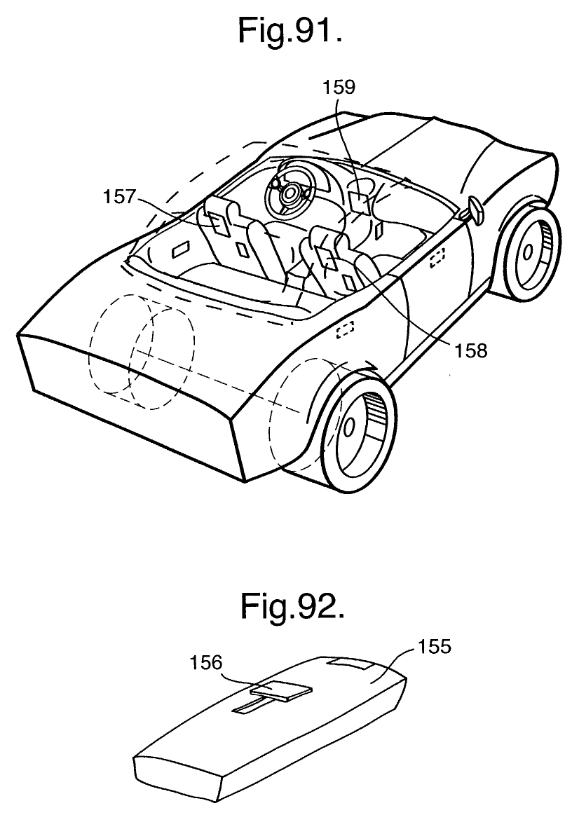

FIG. 92 shows a typical remote control unit for use, for example, with apparatus mounted in a seat back or side wall/door.

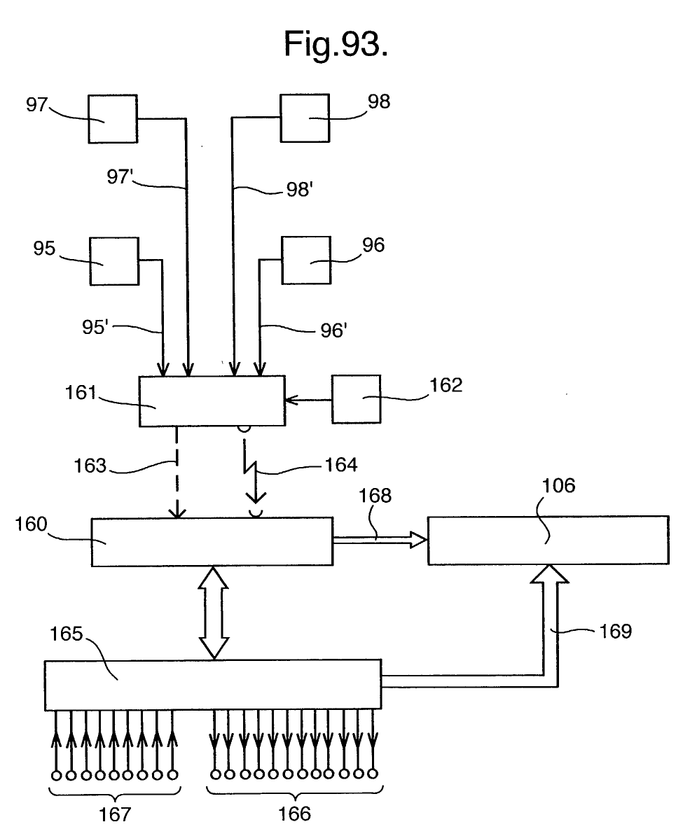

FIG. 93 is a simplified block diagram of a typical system.

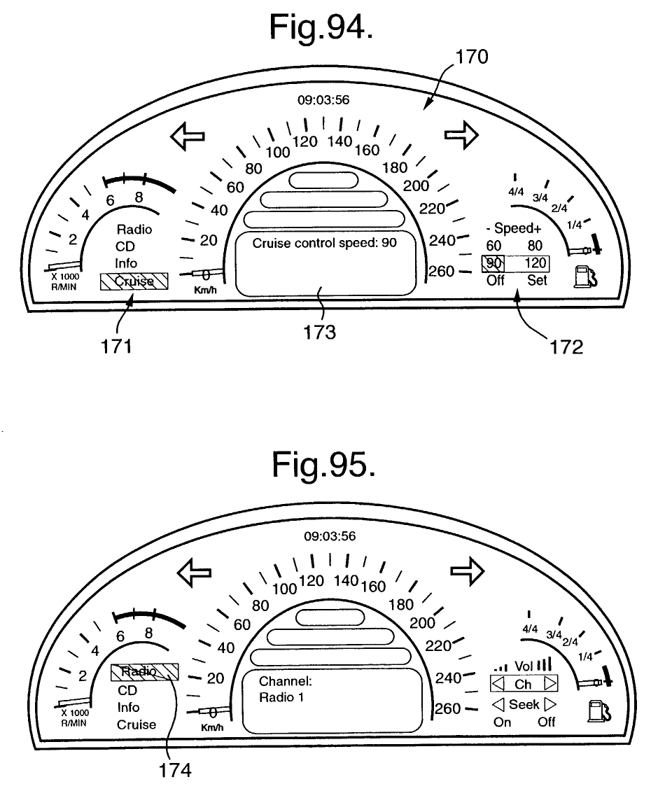

FIGS. 94-98 show alternative option fields in connection with a display panel on a vehicle's dashboard.

FIG. 99 shows alternative option fields in connection with a display panel on a vehicle's dashboard.

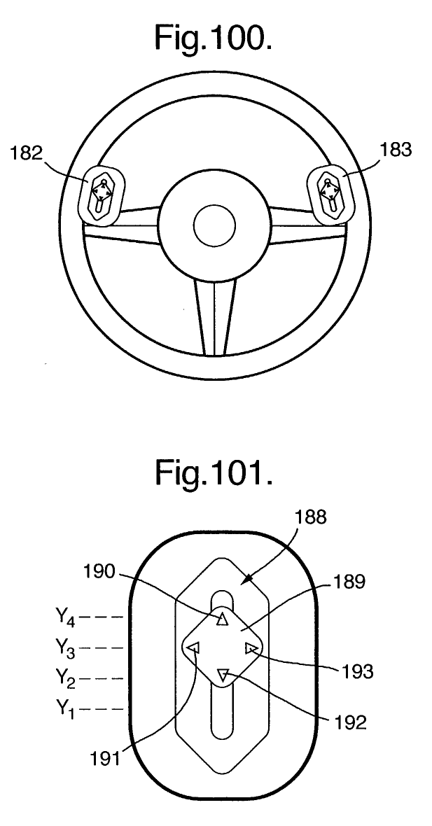

FIG. 100 shows four-way tiltable, stepwise movable multifunction switches mounted on a vehicle steering wheel.

FIG. 101 shows a multifunction switch as shown in FIG. 100 in more detail.

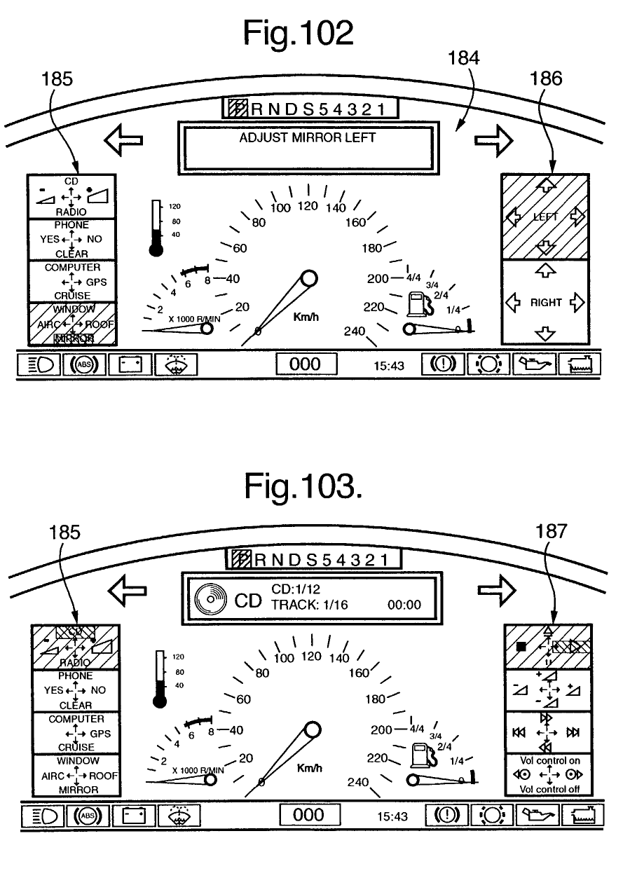

FIGS. 102 and 103 show a display screen that is an integral part of the dashboard for use with a sliding switch as shown in FIGS. 100 and 101.

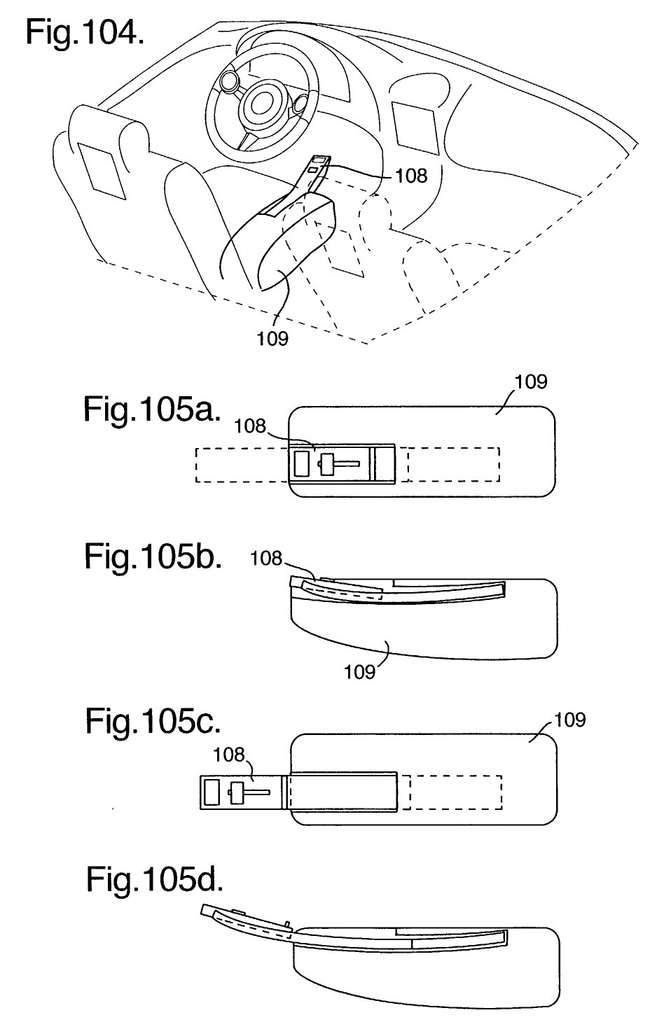

FIGS. 104 and 105 show a switch module with sliding switch mounted in an arm rest in a vehicle.

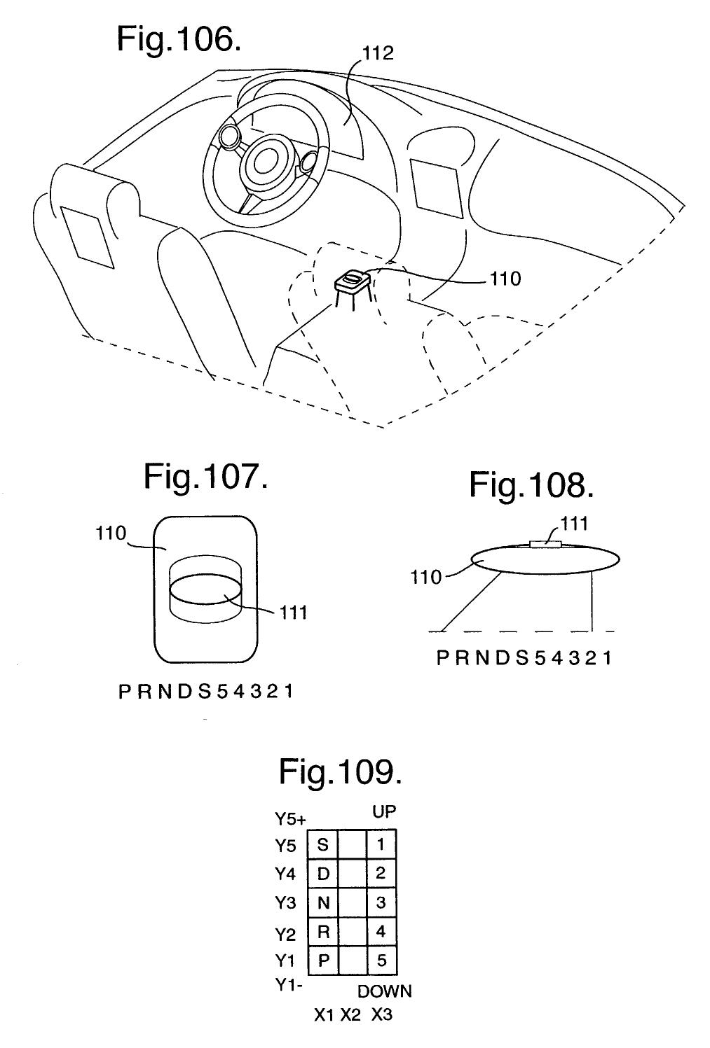

FIGS. 106-109 show a solution for a multifunction switch of the sliding type mounted on the centre console of a vehicle.

In the present invention, the arrangement makes use of a multifunction switch or several multifunction switches. Optionally, these multifunction switches may also be combined with switches that are known per se. FIGS. 6 and 9 show, as a non-limiting example, such a switch mounted in a steering wheel (see FIGS. 1-5) or similar control or steering means for use in an automobile and other craft requiring a driver, but which allows the driver to control all the relevant functions and commands without taking his hands off the steering wheel or moving his eyes from his field of vision. As a non-limiting example, the present description describes the use of the arrangement for installation and use in a car.

Today, some car manufacturers have simple switches that are mounted in the steering wheel. However, the functions that can be controlled by such switches on the steering wheel are quite limited. Known functions which today are found mounted in steering wheels are those associated with the horn, the radio or music system (including volume, on/off button, selection of radio waveband, station choice or selection of a piece of music on a cassette or CD). Furthermore, there are functions for speed control, so-called “cruise-control”, and possibilities for answering or ending a mobile telephone call. However, there is no input system in this connection.

The switch in the arrangement may, for example be designed according to the principles described in previously mentioned International Patent Application No. PCT/NO99/00373, although this should by no means be understood as defining the limits of the use of the invention.

A switch 1 as shown in FIGS. 6-14 has 3x and 4y positions, and two tilting positions, see in particular that shown in FIG. 14. This pattern will also be reflected in the design of the display or dashboard. A switch button 2 is slidable in the Y direction and depressible and tiltable for the x positions. In addition, it has two extra positions 4 in the Y direction, for functions such as “browsing through” and changing menus. In this connection, reference is made to FIG. 14. When the switch button 2 is released, the switch will return to a fixed position, e.g., a central X₂ position and an upper Y₄ position. All the positions of the switch are preferably distinct and may optionally also be felt by a finger. This applies in the case of depression, tilting (the X position) and sliding between the Y positions. This is accomplished in that the switch 1 in a known way has integral notches which in interaction with springs in this case give feedback to the driver during use. Thus, after a brief period of use, the user will be able to employ the switch 1 for simple functions without having to look at the switch itself FIG. 15 illustrates methods of use, the reference numeral 6 indicating the Y direction and positions and 7 indicating X positions.

The switch 1 is preferably mounted so that it can be adjusted to meet the user's needs in the best possible way. This is done in that the switch 1 is rotatable so as to adjust the angle to the driver's hand or thumb that is to operate the switches. FIGS. 6 and 15, FIGS. 3 and 9 and FIGS. 11 and 12 show three designs for such adaptability, where the solution according to FIGS. 6 and 15 permits rotatability parallel to a reference plane about a centre point, rotatability in the reference plane about an end point, and tiltability relative to a reference plane. In this connection, the reference plane can refer to a surface plane of the switch. The positions of the switch can be adjusted step by step or steplessly. The switch is held in the selected position, e.g., by means of magnets 10 that are mounted under the switch housing 3. In this connection reference is made to FIGS. 11a and 12a. Two or more such magnets 10, for example, may be used in connection with the holder 3′ that is designed to accommodate the switch housing 3. In the bottom of the holder 3′ there may advantageously be an opening 3″ for the passage of wires that form a connection with the switch elements inside the switch housing. Alternatively, the actual switch housing may have such magnets that interact with a holder of a ferromagnetic material. Advantageously, the holder 3′ for the switch housing 3 is cup-shaped having circle-segment cross-section, where the segment spans across an arc that is greater than 180°, as is shown in FIG. 11b and FIG. 12b. This will prevent the switch housing from becoming unintentionally dislodged from the holder 3′ when rotated.

As an alternative to the said magnets, it is possible to use a spring-loaded ball 10′ that forms engagement with an engaging surface 10 ″ on the holder 3′, so that the housing 3 finds its desired position.

The adjustment possibilities shown in FIGS. 11a, 12a and 11b, 12b permit the selected adjustment of the switch relative to the steering wheel to be stable. The degree of adjustment will of course be dependent on both the design of the actual switch and the use thereof.

FIG. 15 shows an adjustment area 11 that covers an angle of 90°, but this should by no means be understood as limiting for the invention.

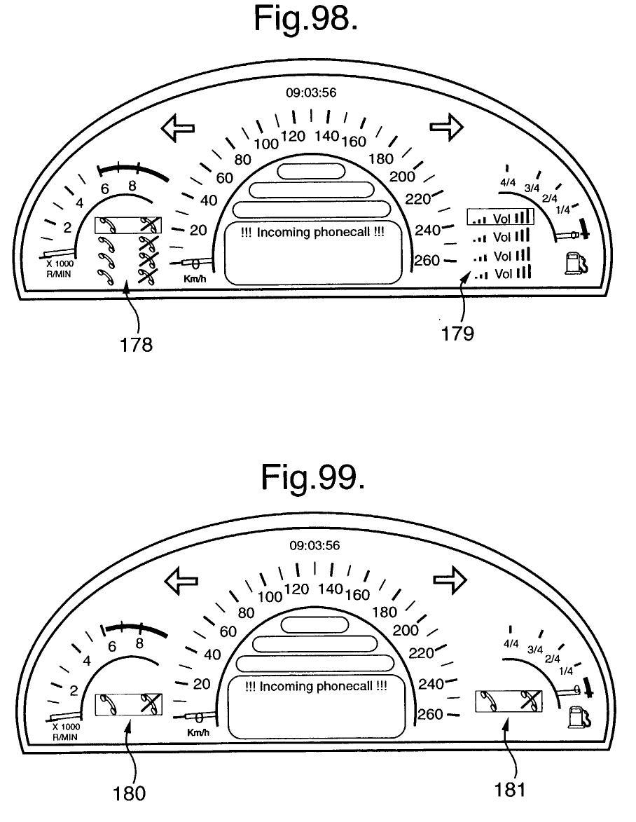

The switches 9, 9′ shown in FIG. 13 are primarily for navigation in menus and, for example, on the Internet. In this connection, reference may be made, for example, to the embodiments of such switches described in International Patent Application PCT/NO99/00373, see in particular FIGS. 98-103; 104-115; 116-123. A typical tilting adjustment relative to the steering wheel 5 is not shown for this solution, and a switch of this kind is primarily not intended to be used by the driver while driving. The switch structure 9 has a rotating function that can be used when navigating on, for instance, a display screen. The switch will be especially useful in connection with large menus, and on the Internet. In addition to being rotatable 360°, it also has four depression positions, indicated by the reference numeral 8 and spaced 90° apart.

The transmission of energy and signals should be stable. Such transmission can, for instance, take place via a cable, e.g., via a cable winding 25 as shown in FIG. 19, or sliding contacts 26, as shown in FIG. 20. The winding 25 can be connected to the steering column at a connection point 25′ and to the steering wheel at a connection point 25″. In FIG. 20, the sliding contact elements are indicated by the reference numerals 26 and 26′ respectively. Transmission of energy may also take place in conventional ways per se.

Transmission of signals from the switch or switches to the car dashboard can either take place via said cable 25 or via the sliding contacts 26, 26′, but transmission of the signals wirelessly using light, an inductive connection or a radio-based connection is also feasible. When using light, it is possible to use a direct optical connection or an optoelectronic connection, either by using laser, infrared light or visible light. Of course, it is also possible that light connection can take place via, for example, a fibre-optic cable.

By way of example, an optoelectronic connection is indicated schematically by the reference numerals 18 and 19 Transfer of data can take place via a fixed connection such as via cable 25, whilst applications that do not have a direct impact on safety functions can advantageously be transferred wirelessly.

Some functions ought to be controlled by breaking the paths through which the switch signals pass at the junction between steering wheel and steering column on certain turns of the wheel. The flow of data and/or energy can be coded so that it is broken at certain turns of the wheel. This may be done, for instance, as indicated in FIGS. 17 and 18 where there is a circle of contacts 20, termed a dial, which in a known way per se can be coded so that at all times it is possible to read the turn of the steering wheel in degrees. This can be done optoelectronically by in a logical manner having an expedient number of light emitting diodes and sensors which after decoding can provide information regarding the turn of the steering wheel. For instance, the number of contacts or fields 20 can be counted successively by an optoelectronic device. The reference numerals 18 and 19, as they are shown in FIG. 18, illustrate the possibility of an optical connection between the steering wheel and the steering column. FIG. 18 also indicates the sliding contact option that exists with respect to reading off degrees (turn of the steering wheel).

As shown in more detail in FIGS. 16 and 17, the switch 1 and/or 1′ can, for example, transmit data and/or current via the steering wheel 5, the connection 18, 19 and a connection 15 to a microprocessor 17 that is adapted to process and distribute data to a display 16 and to various functional devices 30 and 31 found in the vehicle 40. In FIG. 16 the power supply (battery or generator) is schematically indicated by the reference numeral 32. Transmission of switch data may, for example, be carried out via a microprocessor 17′ that is mounted in the steering wheel for converting switch signals to data in a data frame containing synchronisation bits. Synchronisation bits function in that in a row of unknown, serial data there is a known number of data which must come in the right sequence in order to synchronise the data frame, so that the desired data become available. This means that the switch only needs one line in and out in addition to power supply and power supply to an optionally mounted microprocessor 17′ in the steering wheel. If there is a pure electric cable connection between the switch unit and the dashboard microprocessor 17, the use of microprocessor 17′ will not necessarily be required. If, however, the conductor connection between steering wheel and steering wheel column is to be capable of simplification, this will require a coding of the switch signals and a subsequent decoding of the switch signals in the microprocessor 17. According to one proposal, data to applications which may disturb the driver, for example, input and navigation of various on-line functions, will not be available at selected speeds and/or turns of the wheel, but can nonetheless be present when the car is stationary. This is related to the fact that certain functions will require extra concentration on the part of the driver in relation to that shown on the display screen. In connection with the use of synchronisation bit technology, there are, as a rule, few requirements as regards the use of advanced electronics in the steering wheel. Thus, there is not always a need for a microprocessor, but for instance just a cyclic scanner in the steering wheel.

In FIG. 18 the dial 20 is indicated for use in detecting turns of the steering wheel. An optoelectronic detector 20′ may be provided for reading the dial. When a turn of the steering wheel exceeds 15°, for instance, a detector unit 20′ will detect this and, if programmed for the purpose, can cause the power supply to the steering wheel switches and microprocessor 17, where installed, to be stopped. The on-road and other applications that cannot disturb the driver will preferably always be activated via the data connection 18, 19. In FIG. 16 the block 27 indicates functions that are connected to the on-road aspect of the car and the block 28 may be related to additional applications. On-road functions include, for example, gear change (involves an automatic gear system), speed control (cruise control), direction indicators, driving lights (change between low beam and high beam), electrically controlled functions, e.g., windows, seats, sunroof etc. Examples of optional applications include mobile telephones/on-line services, navigation (GPS), radio/music/TV/video and on-board computer.

Basically, the switch or switches can be operated in two main ways If the switch only serves the purpose of operating devices that are in direct connection with on-road operations, the switch will of course be active all the time. If the switch is to operate applications such as a mobile telephone and/or radio, it will not be operative at a predetermined, exceeded turn of the steering wheel, and/or above a certain speed for the vehicle (automobile on the road). It is also expedient that the switch should be completely inoperative when the car is being reversed. It is also possible to choose just one switch for all functions, which will require several modes of operation, i.e., several code patterns for the respective possible positions of the switch. The use of two switch devices which each control respective main functions is also conceivable.

Seen in relation to FIGS. 21-23, for example, the switch 1 can be connected to on-road functions, such as said gear change, speed control, direction indicators, driving lights and electrically controlled functions. The individual functions may be in separate modes which can be shifted between when in use. This switch will always be operative when the vehicle is being driven, and signals from the control button 2 to the car's functions and dashboard can, as mentioned, be transmitted via cable, sliding contact or wirelessly. A wireless connection may for reasons of operational safety be less suitable than a cable connection, but exists as a real alternative. The direction indicator could be controlled by the switch 1 in addition to being controlled manually, and will be connected to a sensor system which can cause the direction indicator to be disconnected on the return of the steering wheel to a starting point or a zero setting thereof

When, for example, direction indicators are to be used, use is made of the arrangement which on normal driving is activated in a drive mode. To indicate, for instance, a change of lanes, the driver flicks a switch button to the right or the left, depending which way he wants to go, e.g., to the left when changing lanes to the left When the steering wheel is moved back to the starting point, the direction indicator will be turned off. This is done in that sensors, such as the sensor 20′, detect the degree variations positively and negatively. On a negative reading (the steering wheel is moved back), coding will cause the direction indicator to be disconnected. The direction indicator can of course be disconnected manually by using a switch 1.

The switch to the right, as indicated by the reference numeral 1, is related to the optional applications. The various functions here are in separate modes which can be shifted between when in use. Not all of the functions of this switch 1′ will be available at selected turns of the steering wheel and at selected, high speeds. When this switch is to be accessible the driver can be set (programmed) as an option according to the driver's age, background, profession and the laws and rules that apply in the country in which the car is used. Access to use of the switch may also be set, for example, according to weather and road conditions, and city driving or country driving.

The switches 9, 9′ are used together with navigation in menus for on-line functions, and it will be possible to dedicate one of the switches, e.g., the switch 9′, to volume control of the radio. The possibility of implementing all, or almost all, of the functions in the car for control from the steering wheel will allow the number of switches normally necessary in association with a steering wheel and dashboard to be reduced considerably, whereby many savings are made as regards space, cables, switches and switch connections.

At speeds of more than, for example, 10 km/hour, a turn of the steering wheel that exceeds, for instance 15° to one side or the other will mean that the dialling of a number on a screen linked to the mobile telephone is not possible or that a text message or e-mail cannot be written. FIG. 18 shows a steering wheel column with a dial 20 that can be read optically by an optoelectronic device 20′, or optionally by using a sliding contact.

As will be seen from that shown in FIG. 21, the most used functions in connection with the arrangement will be present on a display screen 16 that is positioned on the car dashboard 21, or at a location close to the dashboard, but preferably in the driver's field of vision. All on-road functions and data will, like those known in today's systems, be presented on the dashboard. For secondary functions, a menu from which a selection can easily be made by selecting a group of functions could be displayed. All movements related to the switches 1, 1′ and 9, 9′ can be followed on the display 16 in the same way, so that the driver does not need to watch the physical movement of the switch by looking at the switch. Functions that are not used all the time, as for instance a telephone or the Internet, can be shown on an additional display 22 (see FIGS. 21 and 22) which could be opened up or raised from the dashboard in order to enter the driver's field of vision. The display 22 can be made so that it does not obscure a vital field of vision. It is also possible to connect to this display 22 functions that are not used when the vehicle is being driven, or assign these to a centre console 29, as shown in FIG. 23. The display 22 may optionally be made partly transparent, so that it does not to any very considerable extent prevent the driver from seeing forward in the direction of travel.

It is also possible, according to prior art per se, to project information into a direct field of vision of the driver, e.g., onto the windscreen as a transparent image. It is also conceivable that special glasses could be provided to enable driver to see better whilst driving (e.g., with an additional possibility for infrared filter/night vision), and with today's technology it is possible to put such information in the glasses so that the information is projected directly onto the driver's retina. However, solutions that may be suitable for use in connection with motoring have not yet been developed.

The multiswitch, such as the switch 1, 1′, may work, as mentioned by way of example, in a 3X; 4Y system, and this configuration is indicated in a purely schematic manner in FIG. 14. The configuration shown in FIG. 14 will also appear on the displays, such as the displays 16 and 22. Thus, it is possible in a simple way to find the right functions in the menu and in addition not have to observe the switch or look for the switch before use.

Use of the outlined arrangement will make it possible to control, for example, one or

more functions in a vehicle:

Mobile telephone, including menu system, input of numbers/letters etc.

Direct connection (optionally via a mobile telephone) to the Internet and/or e-mail.

TV and/or video

Radio/music system

On-board computer

GPS/navigation

Electrical applications, including electric windows, electric mirrors, electric sunroof, electrically adjustable seats, electric heating in windscreen and/or rear window and/or side windows.

Speed control (cruise).

Gear control.

Levelling where this can be controlled manually.

Four-wheel drive where this can be controlled manually.

Fan.

Setting of temperature/air conditioning.

Warning lamp in connection with accidents.

Horn.

Lights, including headlamp flasher and especially changing between low beam and high beam.

Direction indicators, where the switch may be in interaction with the turning of the steering wheel, and data to direction indicator activation can be broken by turning the steering wheel back to a neutral position. Information can be sent via a laser or via optoelectronics.

Windscreen wipers.

The implementation of all the above-mentioned functions in switches on the steering wheel will mean that in total there are considerably fewer switches in the car, that no switches or handles project from the steering column, which considerably reduces mechanical transmissions, and also that the number of connections and cables connected to conventional switches is greatly reduced in number.

The purpose of mounting function switches on a steering wheel is, as previously indicated, that they are to be in close proximity to the driver's hands. If the switches are fixedly mounted in the steering wheel, they will inevitably follow the steering wheel and the driver's hands when the steering wheel is turned until the driver must change his grip on substantial turns or rotations of the wheel. In connection with driving that calls for substantial turns of the steering wheel, such as parking in a pocket or similar situations, it is quite likely that the wheel will not remain in a normal position, but for example at 180° relative to the normal position, i.e., upside down. This will inevitably confuse the driver on use, with the result that he must think invertedly or upside down to be able to operate the switches, as they are suddenly on the opposite side of the steering wheel. Alternatively, he must wait until the steering wheel is in a normal position. Another factor in the event of extreme turns of the wheel will be that the driver is so involved in driving the car that from a pure safety point of view he should not do anything else at the same time. However, when driving at low speed, such as in side streets with many unexpected crossroads, when looking for a space in a car park, when reversing and when parking in a pocket, it may be expedient to be able to use the switches. With fixed switches which are increasingly common today, the driver may easily be confused when the steering wheel is upside down and the switches have apparently changed “places.” Thus, the functions will also in reality be turned upside down. It is also normal practice that a driver should not cross his arms whilst driving. Furthermore, it should be possible to operate the switches without having to look at them all the time.

In the present invention it has been proposed to have two permanently mounted sliding and pressure-operated switches, which preferably have an associated tilting function.

In FIG. 24 the switches are indicated schematically by the reference numerals 51 and 52 respectively in connection with a modified steering wheel 50. As indicated, the switches are mounted close to the ring body of the steering wheel, so that the switches can easily be operated whilst the driver is holding the steering wheel. However, it is an object of the present invention that when the driver changes his grip on the steering wheel in connection with substantial turns of the steering wheel, the switches will be able to change functions, i.e., when, for example, the switch 51 takes the place of the switch 52 and vice versa when the steering wheel has been turned 180° as shown in FIG. 27. Marking of the switch functions is shown schematically in FIGS. 24 and 27 by reference numerals 51a and 51b for the switch 51 and 52a, 52b for the switch 52. When the steering wheel is turned about 90° from its normal position, the switches 51 and 52 will normally change functions, the switch 51 exchanging function with the switch 52 and vice versa. Thus, what was the left-hand switch before now operates as the right-hand switch and vice versa. By using switches having a sliding and pressure-operated function, and optionally also having a tilting function, the switches will function as if they were in the normal position, even though there is a change-over. This can be done because switches of this type do not require any mechanical changes of functionality when in reality being turned upside down. This means in effect that it does not really matter which way the switch in fact lies, but that the functions of the switches must necessarily be changed when the two switches 51 and 52 exchange positions in connection with the turning of the steering wheel.

It will be seen from FIG. 26 that when the steering wheel passes 90°, the driver will normally change his grip on the wheel. Beyond this point, as shown in FIG. 25, it will be expedient to allow the switches 51 and 52 to exchange functions, so that the driver has a “normal” switch situation even when the steering wheel is upside down as shown in FIG. 27. In this connection, it is essential to ensure that the marking of the switches is correct.

The marking of the switches' functions can be done in different ways based on technology that is known per se.

FIG. 28 shows, as a first example, marking 51a, 51b, where the marking of respective areas is in layers, where the marking 51a is indicated by the upper layer as 53 and the lower layer as 54, and similarly for 51b where the upper layer is indicated by the reference numeral 55 and the lowermost layer is indicated by the reference numeral 56. By using optics and template technique it will be possible to show the desired symbols in respective layers alternately, as light will shift between light emission within either the upper layer 53;55 or the lowermost layer 54;56 by alternating between light sources L1 and L2.

FIG. 30 shows a variant where the markings lie side by side. A variant of the switches 51 and 52 with regard to markings is thus found here, although the switch functions in the switch may otherwise be identical. In this figure the switch is indicated by the reference numeral 57. The markings are indicated by the reference numerals 57a and 57b and specified by the reference numerals 58 and 59. Once again, the use of optics and template technique and the introduction of light on the underside of the markings 58, 59 by means of L1 will cause the markings 58, 59 to become visible.

However, when the steering wheel is turned, for example, 180°, the switch 57 will instead have the markings 60, 61 visible because light L2 is activated instead and passes through the markings 60, 61 as indicated in FIG. 31 and also shown in FIG. 32.

However, it is also conceivable that a further modified switch could be used as indicated in FIG. 34 by the reference numeral 62. What is shown here is the use of two marker fields 62a and 62b, for example, of the LCD type, these being programmable to move the marking from field 62a to field 62b and vice versa when the switch 62 is turned upside down, for example, when the steering wheel is turned 180°, at the same time as the display in each individual field is also turned upside down so as to be legible.

As shown in FIG. 33, and as indicated in FIG. 28, it would be expedient to allow, for example, the control button 51′ to move to a starting position 51″, indicated by the broken lines, when the steering wheel is rotated, for example, 180°. As indicated in FIG. 33, this can be done, for example, electromagnetically by positive or negative pole S1, S2 which will be able to attract the magnet-equipped control button, here for simplicity indicated by the letter M. By giving S1 and S2 a coil structure it will be possible by means of known art per to shift between positive or negative force of attraction, whereby the switch can be controlled in a desired direction in order to have the correct starting position when the steering wheel is turned.

For example, the switch may be in a top position and when the steering wheel is turned so that it becomes upside down, the switch will thus normally come into a bottom position, but because of the solution outlined schematically in FIG. 33 it will be capable of being drawn up to the top position. When the switch thus comes into the “right position”, the field of force in S1 and S2 can be removed.

Marking around the switches is essential, and it is of course important that the function with which a switch is associated both in terms of position on the steering wheel and otherwise should also be marked when the switch changes position on the turning of the steering wheel.

A visualisation of that just described will be more evident upon a study of FIGS. 35-38, and need not per se be explained further in view of what has been described in particular in connection with FIGS. 24-27, but also FIGS. 28-34.

As indicated in FIGS. 35-38, the switches 51, 52 are also indicated by respective references FS#1 and FS#2, which are related to the table below. It will be seen in particular that, for example, the switch 51 can be related to certain control functions, for instance in connection with the control of various operational functions in the vehicle, control of a map system or control, for example of the music centre. The switch 52 may be particularly well-suited for the control of, for instance, telephone functions. However, these examples should by no means be understood as defining the limits of the present invention.

The invention will now be described in more detail with reference to FIG. 39 where the two switches are indicated by FS#1 and FS#2 respectively. A and B for each of these denotes the markings that are present when the steering wheel is in a first area of movement and in a second area of movement respectively, for example, in an area around the normal position and in an area 180° from the normal position. In the area around the normal position, the switch FS#1 will thus have its markings A activated, whilst the switch FS#2 will have the markings B activated. When the steering wheel is then turned through an angle, so that the switches pass through an angle greater than 90°, the switch FS#1 will thus acquire the function of the switch FS#2 and the switch FS#2 will acquire the function of the switch FS#1, so that the switch FS#1 thus has the markings B activated, whilst the switch FS#2 has the markings A activated. According to the invention, a change-over means 63 is provided that communicates with the switches and is controlled by a position sensor 64 that registers the turning of the steering wheel. This position sensor or rotation sensor can be of a conventional type per se, but may also possibly be derived from the detectors or sensors described in connection with FIGS. 17, 18. Consequently, the change-over means 63 which communicates with the microprocessor 17′ (which may be of a type similar to that already described) will ensure that the signals sent to the microprocessor with regard to the functions of the switches will always be correct in relation to the position of the switches on the steering wheel within the defined function areas for the switches during the turning of the steering wheel. However, it will be understood immediately that it may be ill-advised to have these function switches operative when the vehicle driver is in the process of changing the position of his hands on the steering wheel, for instance, when making a turn, so that the steering wheel has, for example, the position shown in FIG. 25A or FIG. 25B.

Below is a table which shows that within a certain angle range, such as the angle α in FIG. 37, there is a change-over between the switches so that they exchange functions, at the same as the switches within this range are also rendered inoperative. This is shown in the table below, where the switch FS#1 is given with its illuminable function marking field A, B, and the same is done for the switch FS#2. The number “1” indicates that the function is active for the switch concerned, whilst “0” indicates that the function is non-active for the switch.

| Angle of rotation | FS#1 | A | B | FS#2 | A | B |
|---|---|---|---|---|---|---|
| 0°-60° | | 1 | 0 | | 0 | 1 |
| 60°-90° | | 0 | 0 | | 0 | 0 |
| 90°-120° | | 0 | 0 | | 0 | 0 |
| 120°-240° | | 0 | 1 | | 1 | 0 |
| 240°-270° | | 0 | 0 | | 0 | 0 |
| 270°-300° | | 0 | 0 | | 0 | 0 |
| 300°-360° | | 1 | 0 | | 0 | 1 |

Thus, it will be seen from the table that in the range of 0-60°, i.e., the steering wheel is either turned to the right or the left, the switch FS#1 will provide the function A, whilst the switch FS#2 will provide the function B. In the range 60°-120° neither of the switches will have a function, whilst in the range 120°-240°, the switch FS#1 will have taken over the function of the switch FS#2 and is thus active for the function B, whilst the reverse applies to the switch FS#2 Also in the range 240°-300° both switches may be inoperative. In the range 300°-360° the same applies per se as for the range 0-60°.

It will be understood that if the vehicle is almost stationary, for example, whilst manoeuvring in a car park, it will not necessarily be required to render the switches inactive in said two intervals. When the driver exceeds a certain minimum speed of the vehicle, it may be advantageous to render the switches inactive. It may also be possible, for example, to render the switches inactive during reversing or reversing at a speed above a certain limit.

Another variant of the present invention will now be described in connection with FIGS. 40-42, which variant is especially linked to retrofitting in vehicles which are not equipped with steering wheel mounted switches, or where such mounting would otherwise be very expensive.

FIG. 40 shows a steering wheel 70 where at least one function switch 71 is mounted on the steering wheel, and in the illustrated example a clamp 72 is used for fixing the switch 71 to the ring body 70′ of the steering wheel 70. A slightly more detailed illustration of the switch 71 and the clamp 72 is given, although somewhat modified, in FIG. 41. In addition to a switch SW of the sliding/pressure/tilting type, the switch 71 also contains a transmitter TX and an encoder ENC which interprets the signals that come from the switch SW and relays these in coded form to the transmitter TX for transmission therefrom. The transmitter TX may, for example, be a so-called “bluetooth” transmitter that communicates with a central processing unit 73 by means of this wireless transmission technology. The central processing unit 73 may in turn feed a display 74, for example, of the LCD type and also, for instance, control a mobile telephone 75. In this way, by using the switch 71, the driver can, for instance, control the mobile telephone 75 without having to take his hands off the steering wheel, and an expedient positioning of the display 74, for example, near the driver's forward field of vision, will ensure minimum distraction of the driver of the vehicle whilst driving the vehicle, here indicated by the reference numeral 76.

A more detailed visualisation is shown in FIG. 43, but in this case, by way of example, there are two switches on the connection piece that connects the ring body 70′ of the steering wheel to the steering column. This area is indicated by the reference numeral 77. The area 77 often consists of a plate or robust arms extending out to the steering wheel ring 70′, and where it is often very practical to retrofit such switches, according to the invention. In FIG. 43 two such switches are shown, indicated respectively by the reference numerals 78 and 79. It will be seen that both of these communicate with the central processing unit 73 and that a display 74 is provided, as is a mobile telephone 75. The switch 79 can, for example, control mobile telephone functions, whilst the switch 78 can, for instance, control the car's music system. However, these examples of functions for the switches 78 and 79 should by no means be seen as limiting for the present invention.

FIG. 44 shows a steering wheel 81 with two sliding, tilting and pressure-operated multifunction switches 82, 83. FIGS. 45a , b and c show a solution where the switch 82; 83 is mounted so as to be rotatable in a holder 84. It will be seen that the multifunction switch 82; 83 is mounted eccentrically in the holder 84. This means that by turning the holder 84, the distance of the multifunction switch to the steering column or the centre 80 of the steering wheel can be adjusted, whilst turning the multifunction switch 82; 83 itself will adjust its angle of adjustment. This can be seen very clearly in FIGS. 45b and 45c.

FIG. 46 shows an alternative embodiment where the operations that will be described in the following can be carried out by using steering wheel mounted touch pads 85, 86 Alternatively, these touch pads 85, 86 may consist of a film key pad or the like, and thus replace the multifunction switch solution shown in FIGS. 44 and 45. It is also conceivable that the said touch pad 85, 86 may be replaced by so-called touch screens. Such screens could show an image corresponding to that displayed on the dashboard display screen. However, the same interactive system could be present in connection with the dashboard for the display of functions.

FIG. 47 shows multifunction switches 87, 88 in the form of a key block having a plurality of switch keys which on depression are designed to actuate a respective switch function.

FIG. 48 shows multifunction switches 89, 90 that are mounted on the ring body of the steering wheel, and where each of these switches consists of a rotary switch having a stepwise rotatable, sideways tiltable and depressible control element, where the tilting position and/or depression of the control element is adapted to actuate respective switch functions, and where the position of the control element is detectable. As shown in FIG. 49, similar rotary switches 91, 92 can be used, and these can, for example, be mounted on the spokes 93, 94 of the steering wheel.

FIG. 50 shows the use of sliding switches having a function similar to that shown and described in connection with FIGS. 44 and 45. These sliding switches are indicated by the reference numerals 95, 96 and they are especially intended for vehicle functions and/or optional functions, whilst the multifunction switches indicated by the reference numerals 87 and 98 are primarily intended for typical fact-action functions in the vehicle.

As previously stated, FIG. 51 defines the plane of the fields or areas which will be described in more detail later in connection with the steering wheel switches. Here, everything is set for a coordinate-related switch movement for activating coordinates related to X coordinates, X1, X2 and X3 and Y coordinates Y1, Y2, Y3 or Y4. FIG. 52 defines directions with regard to X, Y and Z for steering wheel mounted multifunction switches based in a slidable control element 99.

FIG. 53 defines X, Y and Z directions.

As indicated in FIGS. 51 and 52, a multifunction switch in the chosen example will have 4Y positions and will also be related to the three X positions. However, this should not be understood as in any way defining the limits of the invention, but as an example of what in fact can be provided by means of these positions only. The reference N in FIGS. 54 and 55 thus denotes in general the number of stepwise positions that are found in the Y direction. This number can of course be adapted to the number of functions it is desirable to carry out by using the multifunction switch according to the invention.

FIG. 55 shows a solution where the control element 99 on the sliding switch in at least one of its end positions is movable, against spring action, a part of a step M (so-called toggle operation), past this end position for initiating an additional function. Thus, M represents non-fixed positions which come in addition to the Y positions that are the stepwise positions. On actuation of the control element 99, it can be moved to the position M. When the control element 99 is released, it will return to one of the fixed positions indicated by the letter N.

As is evident from the patent applications mentioned above, some functions will be deactivated at certain speeds. Some functions will also not be available to the driver on excessive turns of the steering wheel. This can be ensured by mounting between the steering wheel and the dashboard of the vehicle sensors which detect the turns of the wheel. The functions that it is desirable to have available whilst driving and which should be in operation even on substantial turns of the steering wheel will, for example in connection with turns of more than 90° relative to the normal position for the steering wheel, change places in the two multifunction switches. This means in reality that the first switch takes over the function of the second switch and vice versa when the steering wheel is turned from the normal position through a substantial angle, for example an angle in the range of 60-120°, preferably 80°-90°. Although the wheel has thus in fact been turned upside down, i.e., has been turned through an angle of 180°, the driver of the vehicle will at all times be able to operate right-hand and left-hand functions respectively using the fingers of his right hand and his left hand respectively

In this connection, it will be understood that if one of the switches should fail or in some other way break, the remaining switch will be able to take over its functions, and at the same time operate its own functions. This can be done in that the one switch can be made to shift between right-hand mode and left-hand mode. This could be controlled by sensors which give feedback to the system's computer program that controls the switches with respect to where the switches are located, and also if one of the switches should fail. For example, to be able to shift between the right-hand mode and left-hand mode, it is conceivable that, for example, a switch could be used as indicated in FIG. 55 where the so-called “toggle” mechanism could effect the change-over between the right-hand and the left-hand modes.

In connection with the use of, for example, sliding switches, as shown in FIGS. 44, 45, 50, 52, 54 and 55, it may be desirable in the event of a substantial turn of the steering wheel, for example 180°, and where the two multifunction switches (optionally the four multifunction switches) exchange functions, to bring the control element 99 either to a neutral position or to a position the control element 99 had the last time it was used.

In FIG. 56a the control element is generally indicated by the reference numeral 99 and connected thereto is a toothed rack 100 which can interact with a toothed wheel 101 connected to an electromotor 102 via a gear or a transmission 103. The motor receives control signals from a microprocessor 104 via wiring 105, so that the motor can be made to rotate in one direction or the other. The microprocessor which forms the control unit in this case can be connected to rotation sensors located on or in the steering wheel. When, for example, the wheel is turned through an angle of 90° relative to that shown, for instance, in FIG. 50, the switches 95, 96 will in fact be rendered inactive, and for the driver of the vehicle they are in effect not present for manipulation.

In this inactive period of the multifunction switches, the microprocessor 104 can cause the motor to become operative, whereby the toothed wheel 101 is brought into engagement with the rack 100, as shown in FIG. 56b . When engagement is present, the motor will on a signal from the microprocessor 104 then be capable of controlling the position of the control element 99 to a predetermined position.

As mentioned earlier, the interactive system can be used both to control vehicle functions and/or optional functions. Within this framework, not only can the vehicle functions be controlled, but also could be controlled via the vehicle's on-board computer.

Said main functions can be selected from the group consisting of:

Constant speed setting (Cruise control)

Air and/or temperature setting

Sun roof manoeuvring

Adjustment of mirrors, seat, steering wheel or on-board computer

The said optional functions may be selected from the group consisting of, for example, telephoning, radio operation, use of CD player, use of GPS, use of the Internet, use of e-mail, or use of document processing

However, there are some fast-action functions which are not immediately suitable for searching through a menu and manipulation, and where the time factor is quite important for reasons of safety. This relates to fast-action functions selected from the group consisting of, for example, the use of lights, shifting between low beam and high beam, use of direction indicators, use of headlamp flasher, use of windscreen wipers, use of windscreen washer, use of horn, use of hazard warning lights or the like, and optionally control of gear change or changing from normal driving pattern to winter mode or sports mode in, for example, an automatic gear box.

Although initially it will be desirable to have two multifunctional switches mounted on the steering wheel, as shown in FIGS. 44, 46, 48 and 49, it may also be desirable to use several switches, as shown in FIG. 50, where for example, the switches 97 and 98 operate the typical fast-action functions mentioned above.

Constant and rapid advances are being made in sophisticated technology which it will be desirable to implement in vehicles such as cars and in other craft and means of transport. Although the present invention basically is shown and described in connection with its use in a vehicle such as a car, it should be understood that “vehicle” is also taken to mean to any craft or means of transport that is designed to be steered

However, for the sake of simplicity and for the understanding of the actual invention, the description is based on the use of the invention in connection with a private car. However, this should by no means be understood as defining the limits of the invention

FIG. 57 shows a section of a dashboard 106 which the driver will be able to see through the openings in the steering wheel when driving in a normal manner. The steering wheel and multifunction switches are indicated in broken lines and the left-hand steering wheel switch, here indicated by the reference numeral 82, will control main functions as shown in the left-hand field or area 107 on the dashboard 106. The right-hand function switch 83 will control subsidiary functions as shown in the right-hand field or area 108 based on choices made from the left-hand area 107.

FIG. 58 shows a main menu on the dashboard display screen 106. Of course, the functionality of the system and the symbols used will only be reproduced here as examples for the understanding of the innumerable uses of the system and should by no means be understood as limiting, and not as regards the graphic design of the symbols either. As in FIG. 57, the left-hand area is indicated by the reference numeral 107. This area 107 corresponds to the multifunction switch located to the left on the steering wheel, i.e., the switch 82 as shown in FIGS. 44 and 57, but also similarly positioned switches as shown for example in FIGS. 46, 47, 48, 49 and 50. This means that the switch 82 is to the left of the driver if the multifunction switches are made so that they can exchange functions when the wheel is turned, as described earlier. This main menu, as shown in the present example, includes CD player 108, telephone 109, radio 110, sunroof control 111, GPS 112, on-board computer 113, control of electric windows 114 , air conditioning adjustment 115, steering wheel adjustment 116, mirror adjustment 117, sub-menu 118 and seat adjustment 119. The right-hand area, indicated here by the reference numeral 108′, will change as regards content, depending on the choices the driver makes as regards options in the left-hand area 107.

A gear selection 120 area is shown at the top of the display screen on the dashboard The whole dashboard can in reality consist of a digital screen or a screen of the PC type, optionally as a liquid crystal display screen. A combination of analog instruments, such as instruments 121, 122 and 123 for indication of rpm, display of speed and fuel level respectively is also possible. However, it will be understood as regards the indication of rpm, speed and fuel level, that all of them or just some can be shown on the display screen 106 as a digital display. To ensure normal vehicle safety, it may be prudent to have present, for example at the bottom of the dashboard, a field 124 which in digital form indicates the speed of the vehicle. Furthermore, there may be provided, for example at the bottom, fields which in a conventional manner indicate the activation of high beam 125, brake function via ABS 126, battery charge function 127 windscreen washer fluid 128, brake warning 129, brake lining 130, state of lubrication 131 and engine control 132. The left-hand area and the right-hand area 108 or 108 will be digital, and there will also be a central field or area 133 in the middle of the dashboard. This can be made so that during most operations the area will not cover the speedometer. Nonetheless, in connection with functions that may require more space, the screen will take up the whole display area. However, this will only be available for functions that cannot be in use during driving. As mentioned, for reasons of safety it is often desirable to have a bottom display field 134 where high beam, ABS brakes, battery charging, etc are represented by the conventional warning symbols In addition, for example, the time can also be shown, as indicated by the reference numeral 135. The functions indicated in the bottom area 134 are normally functions that only appear as warning lamps if departure from the normal status occurs. This warning field 134 may of course also be positioned at other locations on the dashboard, for example, uppermost therein, or be removed from its given position and implemented in, for example, the main menu field 108 However, it must be said to be advantageous in terms of safety for warning functions to completely function-independent of the other functions described here. At the same time, it will be seen that electronics and software are developing at a furious pace, and that “safe” systems will gradually replace the traditional systems that use light bulbs for warning.

FIG. 59 shows a screen image of what could represent a natural, neutral driving situation. Here, in a normal driving mode the adjustment of speed (cruise control) will be relevant and will be shown in the right-hand field, indicated in this figure by the reference numeral 108a, and desired adjustment could be made by operating the multifunction switch located on the right had side, as for instance the switch 83 The movement of the right-hand switch 83 to position Y3 and tilting/depression at position X3 will result in the selection of a speed of 80 km/hour. The control system of the car will be programmed to accelerate the car naturally. By making, for example, a double click in position Y3, X3 or optionally a long click, the driver can program the car to accelerate quickly up to the selected speed in response to a so-called kick-down function. By using the arrow keys as shown in the field or area 108a, the speed can be finely adjusted manually

A movement of the left-hand multifunction switch, for example, the switch 82, to the top will result in the upper field Y being marked. A central depression in position X2 will cause the telephone function 109 to be activated.

FIG. 60 shows the dashboard in connection with the telephone function. In the telephone mode, the left-hand area 107a at position Y4 will split the telephone function, so that the driver through the left-hand multifunction switch has three options in this mode, namely X1 for ringing, X2 for cancelling or return and X3 for hanging up/closing the call/disconnecting. The right-hand area is indicated here by the reference numeral 108b and will show the number that is chosen by using the right-hand multifunction switch, as for instance the switch 83. The result of the input is shown in a field or area 136 which can appear, for example, in a central upper portion of the dashboard display screen 106. This area 136 will only be visible during active use of the multifunction switch for operations of a telephonic nature. During the call, i.e., when the connection has been made, the field or area 136 will, for example, be able to disappear automatically. This may be advantageous as it will ensure that whilst driving the vehicle the driver does not take all focus away from on-road information that is on the display panel. The driver himself can retrieve the image by moving one of the switches. If the driver is listening to the radio or music and the telephone rings, the sound of the CD or radio will be turned down or off, as otherwise is conventional art. If the driver does not want to take a such call, he can depress the switch at position Y4,X3 and any sound will then return. This will also happen when a telephone call has been ended.

In this connection, it should be mentioned that the system used in this type of switch in connection with telephony has been described in part in the Applicant's earlier International Patent Application No. PCT/NO00/00412.

FIG. 61 shows the choice of CD player by selecting position Y4,X1 in connection with the main menu 107 The use of the CD player can be effected by means of the right-hand multifunction switch and by choosing the desired option position in the right-hand display area 108c.

FIG. 62 shows what the area 107 looks like in connection with the choice of radio at position Y4, X3 by manipulating the left-hand multifunction switch, such as the switch 82. Y1 on the right-hand area 108d shows two direction arrows in addition to conventional symbols for radio use. By entering Y1, X1, it will be possible to change channel selection in field Y2 on the area 108e, see FIG. 63.

In FIG. 64 the dashboard display panel is used in connection with the selection of GPS (Global Positioning System). As is known, this system consists of a computer-like unit which has software containing data for road maps covering a predetermined area. It will be possible to look at maps of certain areas and choose a destination. The system transmits signals via an antenna on the vehicle to at least one satellite included in the GPS system and which detects in this case the position of the car On the basis thereof, the computer will calculate the fastest route on the basis of the map material it has stored and can with the aid of direction arrows on the screen and/or sound (voice commands) lead the driver to the destination that has been predetermined. Known methods for input and processing of a GPS system that is available today (often a combination of many pressure-operated switches which together with arrow function and perhaps a type of rotatable switch can make the choice) for use in a car is very laborious and illogical to use in practice.

FIGS. 64-66 show the use of the GPS system in practice. However, it will be understood that what is shown here merely serves as an example to be able to understand the possibilities that the system in fact provides.

The figures show how through the use of two sliding, tilting and pressure-operated switches the system can easily be used interactively. In FIG. 64 the multifunction switch has been moved to position Y3 (see for example FIG. 58). Pressure in position Y3, X2 will activate GPS and show a screen image 137, see FIG. 64, which may consist of a map. The right-hand area 108f shows the alternatives available for navigation in the map, where it is possible to zoom in and out, and to navigate to the right, the left, up and down across the map in the screen image. The screen image now has the appearance of a main menu as shown in FIG. 57 and indicated by the reference numeral 107b. It can be seen that the left-hand area in position Y3 on depression at point Y3, X2, as stated above, will cause the Y3 field of the area 107 to change character and become that indicated by the reference numeral 107b, the field being split into three, where the left-hand Y3, X1 gives input possibilities for numbers when using the right-hand multifunction switch, the centre position provides clear functions, whilst the right-hand option will give input possibilities for letters by using the right-hand multifunction switch. The screen image shown in FIG. 60 shows how the left-hand area again can change after selection has been made, in this case the selection of Y3, X3 for the input of letters, writing. This mode can be used to enter, for example, a destination. The right-hand area 108a in FIG. 65 shows the alphabet where the letters are in groups of three. Selection of ABC by depressing the right-hand function switch in position Y4, X1 will further split the letter group, as can be seen in FIG. 66, and it will thus be possible through the use of the function switch in position Y4 to choose the relevant letter for input in a display field 138, as shown in FIG. 65. The left-hand area of the display screen is indicated by the reference numeral 107c in FIG. 65. Here, it can be seen that the field for Y3 has changed character in relation to the corresponding field Y3 for the area 107b.

FIG. 67 shows what the right-hand area 108h may look like on the choice of Y3, X1 for numbers in the left-hand area indicated in the figure by the reference numeral 107d. The right-hand area has arrows (position Y1) for selection of additional symbols and functions. The use of these arrows causes the fields Y2-Y4 to change and show further options (not shown in the figure). This system can be programmed as required and in reality is it only the imagination that limits the possibilities here. It could involve the control of all the applications that may conceivably be implemented in a car or other driver-controlled vessel, craft or means of transport.

FIG. 68 shows how in the left-hand area the field Y3 of the main menu has changed, so that the area, here indicated by the reference numeral 107c, has the same appearance as in FIG. 65. The choice of Y3, X3 in the right-hand area 107 will confirm the destination entered in the system indicated in the field 138. A new field 139 which can direct the driver to the destination by means of text and arrows will appear on the display screen. This can also be assisted by sound or voice direction. By means of an arrow chosen in the right hand column, here denoted 108f and also having the same appearance as that shown in FIG. 64, it is possible to enter symbols in order to change, for example, to display maps with route information. However, this is not illustrated in the figures

FIG. 69 shows a main menu 107 in the left-hand area, and the selection in the left-hand area of the field Y2, X2 will give options for setting air and temperature. In the right-hand area, indicated in this figure by the reference numeral 108i, the field Y3,X2 has been chosen in the illustrated example, and here a larger figure can optionally be shown separately on the screen, and where a dark arrow indicates warm air down and a light arrow indicates fresh air up. The screen image can, as required, disappear after a short time, but can also be generated again by moving the right-hand multifunction switch, such as the switch 83. It will also be understood immediately that the selection of other fields in the area 108i will give other adjustments of air conditioning represented by symbols that are generally accepted in, e.g., the automobile industry.

FIG. 70 shows options in the main menu represented by the left-hand area 107, where the field Y2, X3 has been selected by using the left-hand multifunction switch and relates to the adjustment of the car steering wheel in relation to the driver. The choice of this function will result in the appearance of options for electric steering wheel adjustment in the right-hand area 108j in FIG. 70 in the form of arrow options, where Y4, X2 moves the steering wheel up, Y3, X1, moves the wheel in, Y3, X2 moves the wheel down and Y3, X3 moves the wheel out.

FIG. 71 again shows the main menu in the left-hand area 107 and in the illustrated example the field Y2, X1 in the area 107 is chosen for control of windows. The right-hand area, indicated in the figure by the reference numeral 108k, shows the rear right-hand window at Y1, the rear left-hand window at Y2, the front right-hand window at Y3, and the front left-hand window at Y4. Arrows in position X1 control the lowering or opening of a window, whilst arrows in position X3 control the raising or closing of a window. Advantageously, an image of the vehicle can appear simultaneously on the screen 106, as represented by the vehicle 140. There, the chosen window, in this case the front left-hand window, will be marked. Here, by using colours, it would possible to shift between, for instance, red for an open window and green for a closed window The image of the car 140 can, if desired, disappear after a short time, but activation of the right-hand multifunction switch will result in the return of the image. It is, however, essential that displays which may distract the driver and which the driver is not using at that instant should not be shown on the screen 106.

In connection with, for example, the control of windows, there may also be sounds attached to the functions performed to advise the user of driver of what is happening and of any consequences of performing such functions. For instance, it is conceivable in connection with the exemplary embodiment in FIG. 71 that the driver will be advised if it is raining outside and he is in the process of opening the windows. In such a case, there must be a precipitation indicator, but these are known in connection with the control of, for example, windscreen wipers. In other cases, it may be appropriate to warn the user that, for instance, it is raining outside when the user is in the process of opening the sun roof by mistake.

FIG. 72 shows the area 107 containing a main menu and where the option this time is the adjustment of external mirrors. This option is chosen by selecting the field Y1, X1 which relates to external mirrors. When this choice is made in the left-hand area, the right-hand area will have the appearance as indicated, for example, by the reference numeral 108l in FIG. 72. The right-hand area shows the adjustment options for the left-hand mirror by using the fields Y3, Y4 and by using the arrow-furnished fields. The car's right-hand mirror can be adjusted by the fields Y1, Y2. At the same time, it may be advantageous to produce an image of the vehicle 141 on the screen where the chosen mirror will be marked. The image of the car 141 can be made to disappear from the screen after a short time However, activation of the right-hand multifunction switch will cause the image to reappear. Thus, it will be understood that manipulation of a multifunction switch as shown and described earlier will allow, for example, the adjustment of external mirrors to be made in a simple, straightforward manner.

FIG. 73 shows the main menu in the left-hand area 107 and where in the chosen example the field Y3, X1 has been marked, i.e., the car sun roof, where installed This field can also optionally be used if the car has a electrically operated removable or fold-down roof (a convertible or soft top). The right-hand area, here marked by the reference numeral 108m, shows the options that will be available. At the same time, it will also be possible to generate an image of the vehicle, indicated here by the reference numeral 141, on the display screen 106. The sun roof, indicated here by the reference numeral 141′, can be marked, for example, by using a change of colour from, for instance, red for an open roof to green for a closed roof. However, the image of the car 141 will normally disappear after a short time, but activation of the right-hand multifunction switch will cause the image to be returned to the screen. The sun roof can be opened in the field X1, whilst in the field X3 the sun roof can be closed. If the sun roof is optionally to be tilted, the field Y2 must be used.

FIG. 74 shows in the left-hand area 107 the modified main menu that appears when the main menu according to the area 107 is selected by marking the field Y1, X1. A split field Y1 appears here, where the field Y1, X1 is related to the head rest, Y1, X2 is related to the back, and Y1, X3 is related to the seat. In the illustrated example in FIG. 74, adjustment of the seat, i.e., field Y1, X3 has been selected. Adjustment options as shown in the right-hand area 108n and also in FIG. 75 appear in connection with this option. The use of arrows in the field Y1, X3 in the right-hand area 108n will enable the user to shift between several functions.

If the field Y1, X2 is chosen in the area 107e as shown in FIG. 76, the seat back can be adjusted. In this case, a right-hand area 108o will appear on the screen 106 which provides the option for adjusting the back forwards or backwards and also allows adjustment of the degree of firmness, if so desired. As shown and explained in connection with, for example, FIGS. 71-73, enlarged pictures of that part of the seat to be adjusted can also be provided, as indicated by the reference numerals 142 and 143 in FIGS. 74 and 76 respectively. On this image, the part of the seat that can be adjusted will be marked and the figure will also be capable of moving in the same way as the adjustments. However, the pictures indicated by reference numeral 142 or 143 will disappear automatically a short time after the adjustment has been completed. If adjustment of the headrest is required, the field Y1, X1 must be activated in the area 107e.

FIG. 77 is related to the use of the on-board computer The area 107 in this case has a marking at Y3, X3, whereby there appears a right-hand area 108p that splits up the various elements in the on-board computer. Here, it will be possible by choosing a respective field in the area 108p to obtain information regarding, for example, petrol consumption, oil level, coolant level, level of windscreen washing fluid, the electrics, battery charge, tire pressure etc. The field Y4 shows at Y4, X1 the general status, whilst Y4, X2 can show consumption and where Y4, X3, for instance, can represent the pre-setting of an engine heater. It is possible that clicking on the respective fields could generate the display of additional information about the status of the car on the screen, for example, if one of the fields shows a coloured marking, for example red, different from that normally shown.

It will also be seen that most of the messages that can be read in the area 108p also appear in the bottom field 135, as the information is important. However, the field 135 will be a field that only provides information if an abnormality occurs, but the multifunction switches as such will have no impact on this field 135.

If in the main menu, such as the menu 107, the field Y1, X2 is chosen, this could permit the use of a PC mode from the steering wheel by operating the multifunction switches, such as the switches 82 and 83, PCs in cars have started to become common, and in particular with a view to use in connection with the Internet and e-mail. The driver of the car can use these applications directly by employing their multifunction switches mounted on the steering wheel. However, the functions should not be employable while the vehicle is in motion, but only when the car is parked and is stationary. In larger craft or vessels such as boats and aeroplanes, however, these functions can be active at all times.

FIG. 78 shows what the left-hand area, indicated hereby the reference numeral 107f, may look like if the user chooses to enter the submenu Y1, X1 in the main menu represented by the area 107. The menu the user is now in will be shown at the top left-hand side of the area. The same also applies to the subsidiary functions of the right-hand area which will be shown.

FIG. 78 shows a submenu consisting of e-mail 144, computer 145, Internet 146, film projection 147, for example, for showing in the back of the car. This function could also be linked to reversing if the rear view is poor from the driver's seat. Optionally, this function may also be programmed so that it automatically comes up on the display in connection with reversing. The reference numeral 148 represents the showing of TV and the reference numeral 149 indicates, for instance, the showing of a film (for example VHS/DVD), and the reference numeral 150 indicates games. In reality, it is only the imagination that set the limits for the applications that can be entered in this menu option area 107f In this mode, there are no function options shown in the left-hand area 108q, as there will not be any function option here until a sub-function in the left-hand area 107f has been chosen However, it will be understood that the function last used for the right-hand area 108q will be shown until another selection is made.

FIG. 79 shows what the screen image may look like if the user on making a selection in the menu area 107f in FIG. 78 selects, for example, e-mail 104 by activating the field Y4, X1.

FIG. 79 shows what the display on the screen 106 will look like in connection with this option. In the area 107g, which is the left-hand function area, there is a list of the main functions that will apply, for example, to an e-mail program that is provided as a direct option on the use of said left-hand multifunction switch. The alphabet is shown in the right-hand area 108r and has been placed in groups of three letters for fast select and input of text (as described earlier) The field Y1 in the area 108r shows arrows for use in fetching additional letters, numbers, symbols etc.

FIG. 80 shows an alternative for control of a cursor on the screen. This is of particular value in connection with the use of the multifunction switches for choosing functions and icons directly on the screen, as for instance in Windows or MAC programs

However, it must be stressed that the sliding, tilting and pressure-operated switches that are described here can easily be made so that they can be programmed to function as a cursor control means in the modes where this is appropriate. In this connection, particular reference is made to that shown and described in the Applicant's Norwegian Patent Application 20003974, where such a solution is taught. In such a case, the navigation options indicated by arrows in FIG. 80 will not be necessary The screen image between the right-hand area and the left-hand area could then have the appearance of a conventional computer screen image, depending on which program is in fact being used.

FIG. 81 shows a function area for the input of text.

FIG. 82 is related to selection of the Internet by choosing the field 146 in the area 107f in FIG. 78, i.e., the field Y4, X3. Here, it will be necessary to be able to control a pointer 151 on the screen. This is necessary in order to be able to make the pointer selections that are usual in connection with so-called surfing on the Internet. The left-hand area, marked here by the reference numeral 107h, shows arrows (Y3; Y4, X2) for control of a cursor by using, for example, sliding, tilting and pressure-operated switches, as for example the switches 82 and 83. Of course, it is possible to replace these types of switches with switches that in addition have possibilities for stepless control. This means to say that the switch in a particular mode and/or position will be capable of functioning as a cursor control means for controlling the cursor 151. The right-hand area 108s will be ready for input of text. However, this area 108s can of course have other underlying functions.

FIG. 83 shows the option of computer 148 in the area 107s in FIG. 78, i.e., the field Y4, X2. Navigation using arrows can be made possible, for example, in that in the computer menu 107g the field Y3, X1 is chosen, whereby a submenu 107h appears, as shown in FIG. 84. Here, it will be seen that in the fields Y3, Y4, X2 there are arrows for moving a cursor 152 on the display screen 106 in the field 153. Input of text that is related to, for example, the menu area 108t can be done as described in connection with the preceding figures, for example, FIGS. 65 and 66. Control of the cursor 152 may optionally also be effected by implementing cursor control in the multifunction switches, as described above. Use of programs will then take place by using a pointer function. By laying out a keyboard on the screen, as shown in FIG. 85, the selection of letters and characters can also be made by using the pointer or cursor 152 and activating this for the individual characters or letters. A solution that seems to be within the scope of invention is that the input of text could be done in that a keyboard configuration is laid out on the actual screen (e.g., in a portion between the left-hand area and the right-hand area, as indicated in FIG. 83 and further illustrated in FIG. 85). By using navigation arrows as shown in FIG. 84, it is possible to move a highlighted field across the keyboard which covers, for example, three options at a time, as shown in FIG. 86. By then pressing to the right, to the left or in the middle of the multifunction switch, as for instance a switch shown in FIG. 44 or 50 or 51, the letters, numbers and symbols required can be chosen quite easily. Main functions, as for instance Shift, Enter etc can preferably act on the whole switch button.

That shown in FIGS. 87-89 and also to some extent FIG. 90 is related to that shown in FIG. 50. FIGS. 87-90 show a function where the steering wheel has a second set of switches, such as the switch set 97, 98 shown in FIG. 50. These switches will work in the same way as the other multifunction switches. In the following example the switches have five fixed Y positions, plus a so-called toggle function in the Y direction (Y6). The switches will control main functions, as for instance direction indicators, horn, windscreen wipers, gear choice, hazard warning lights, low beam and high beam. A left click on the left-hand function switch will produce a direction signal to the left. A right click on the right-hand function switch will produce a direction signal to the right. This could apply for all Y positions in the position X1 on the left-hand switch and the position X3 on the right-hand switch. A central click on the left-hand function switch 97 will give the horn, whilst a long depression for both switches in all Y positions will in position X2 produce a horn signal. This will be the case even though the right-hand switch has gear choices in all Y positions of X2.

The gears can be chosen by pushing the control element 99 of the switch to the correct positions on selection and pressure on the field Y5, S2 in the right-hand area 153. Selection and depression of the area 153 in field Y5, S2 (S=sports gear) will provide a new option in Y1-Y4, X2, see FIG. 89. A left click Y4 or Y5 means that the driver can easily change gears up or down.

The selection of Y5, X3 in the left-hand area 154 allows the determination of, for example, windscreen wiper functions. Y3, X1 represents, for example, lamp washer.

Y3, X3 will represent stepless adjustment of the speed of the windscreen wipers Splitting of the function in connection with selection and adjustment will be made possible by a menu as shown in FIG. 88.

By moving, for example the left-hand multifunction switch to the field Y6, (will return to Y5 without external stimulus), it will be possible to shift between high beam and low beam. By moving the right-hand multifunction switch to the field Y6, it will be possible to activate or turn off hazard warning lights.

FIG. 90 shows an example where the fields 107 and 108 first described (with variants thereof) have changed places with the so-called fast-action functions. As may be envisioned, the car driver will be able to set this himself by, for example, entering it as a setting under the secondary menu Y1, X2. Thus, the car driver can, if he wishes, remove the options from the screen itself when the functions have been learned and established. It is also conceivable that the driver will be able to manage with only the positions Y5 and Y6 on the screen at all, and that the rest can appear the screen on the active operation of the switches.

It is also possible that a car equipped with simple functions will use only primary function switches from the steering wheel (as described in connection with FIGS. 87-90 and in connection with FIG. 50).

Within the scope of the invention, it is also possible that passengers in a car will be able to make use of applications of the system such as comfort (temperature/seat adjustment), windows, computer, e-mail, Internet, telephone, TV, video/DVD, games etc.

As shown in FIG. 91, display screens for backseat passengers are recessed in a known way per se in the seat backs. The front seat passenger can, as shown, perhaps look at a screen in the centre console of the car or have such a screen mounted immediately against a recessed portion in the dashboard.

Multifunction switches for a system of this kind could be of the same type as those mounted in a steering wheel. It is conceivable that a switch of this kind may be mounted in an apparatus that is placed in a console in the seat back or side wall or door and can be removed and used wirelessly to control such applications, see for instance the multifunction unit 155, shown in FIG. 92, where the control element of the multifunction switch is indicated by the reference numeral 156. A switch for use of the system will be of the same type as those mounted in the steering wheel.

The display screens in FIG. 91 are indicated by the reference numerals 157, 159 for back seat passengers and by the reference numeral 159 for the front seat passenger or driver. Although the present description has been related specifically to a multifunction switch of the design which can be seen from, e.g., FIG. 44, it will however be understood that all the other switch designs could equally well be used. As mentioned, the switch design shown in FIGS. 48 and 49 is rotatable, tiltable and depressible. The switches could be mounted around the steering wheel ring, around the “spokes” 93, 94 of the ring or next to these at a place that is convenient for the driver. So-called rotary switches of this type are particularly suitable for navigation of the cursor across a screen. The switch may preferably be implemented in a steering wheel together with sliding, tilting and pressure-operated switches and in such a way that these switch types will complement each other in the use of the various functions for driving and optional applications and fast-action functions. A more detailed description of such rotational switches can be seen from, e.g., the Applicant's Norwegian Patent Applications Nos. 20004770 and 20004771.

FIG. 93 is a simplified block diagram to illustration the correspondence between multifunction switches, displays and control of different functions. The chosen example is based on a steering wheel with multifunction switches as can be seen from FIG. 50. However, it will be understood that that shown in FIG. 93 could just as easily have been used in connection with that which can be seen, for example, from the multifunction switch constellations shown in FIGS. 44-49.

The switch devices 95-98, optionally only 95 and 96 or only 97 and 98, communicate via respective connections 95′, 96′, 97′ and 98′ with a processor 160 via an interface unit 161 which effects the transmission of switch signals to the processor 160. In connection with the interface 161, there may be provided a steering wheel rotation detector 162 which also transmits signals to the processor 160 via the interface 161. Transmission of signals to the processor can take place either via wiring as indicated by the reference numeral 163 or wirelessly as indicated by the reference numeral 164, for example, by using “bluetooth” technology, optically or in another manner. A display is indicated by the reference numeral 106, as in the preceding figures. The processor 160 also communicates with interface equipment 85 in order, with the aid of signals from the processor 160, to control, for example, vehicle functions indicated generally by the reference numeral 166. As a supplement, the interface 165 can also receive, for example, status signals associated with the various functions of the car, and for the sake of simplicity represented here by the reference numeral 167. The signals that come in via the interface 165 will be able to return to the processor 160 which determines what will be displayed on the display 106 by using the transmission path 168. Alternatively, the interface 165 can transmit displays directly to the display screen 106 via the transmission path 169.

The embodiments shown in the drawings and disclosed in the description and claims could of course be the object of innumerable variations without any deviation from the inventive idea as set forth

As described earlier, many possibilities for function control are provided by means of sliding switches mounted on a vehicle steering wheel There now follows a description of a further example of a simple system for use in a vehicle, for instance a car, and in connection with quite simple functions.

As shown in previous FIGS. 2-5, 21, 23-27, 35-38, 43-50 and 57, one switch can be mounted to the left and one switch can be mounted to the right on a steering wheel. The switches work in connection with respective fields located on the left and the right of the dashboard

With reference to, for example, FIG. 2, the left-hand switch 1 can preferably have a sliding function having four steps The right-hand switch 1′ can preferably have four sliding positions, and selection can be effected by means of right or left clicks or tilting By pushing or sliding the left-hand switch 1 to the chosen position, selection can be made instantly, and it is not immediately necessary to depress the switch This will apply in principle to all options shown in FIGS. 94-97 and FIG. 99, but with the exception of that shown in FIG. 98. The right-hand switch 1′ will be able to control the main options that are selected using the left-hand switch 1. It is also conceivable that the system may be so designed that selection from the main menu, as for instance the main menu 171 in FIG. 94 with the aid of the left-hand switch 1, is effected only by having pushed the switch 1 into the chosen position, optionally with the addition of depressing the switch.

FIG. 94 shows said left-hand main menu field 171 in connection with a dashboard 170 on the selection of cruise control. The right-hand field, indicated by the reference numeral 172, shows the options. The speed of 90 km/hour can be selected by moving the right-hand switch 1′ to position Y2 and depressing the left-hand side of the switch. Positions and options will thus be highlighted. To mark the various options and positions in the fields, it is possible to use, for example, different colours and markings in combination with text and symbols. A central field 173 may optionally provide further information regarding the various functions selected.

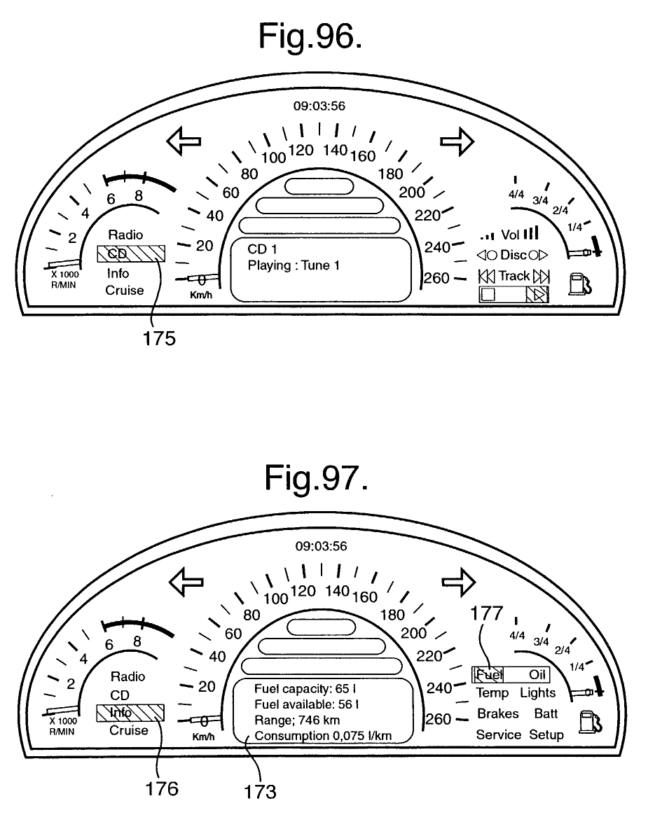

FIG. 95 shows the selection of radio function 174 in connection with the main menu 171, and FIG. 96 shows the selection of CD player, indicated by the reference numeral 175 in connection with the main menu 171.

FIG. 97 shows the selection of “Info” indicated by the reference numeral 176, i.e., an on-board computer containing various data that is directly related to the vehicle and the operation thereof This source of information is controlled as mentioned by a computer (not shown). The central field 173 shows an example of the information it is possible to have presented, e.g., on the selection of“fuel”, as indicated by the reference numeral 177. FIG. 98 shows a dashboard where the function “telephone” normally is not shown in the main menu. If there is an incoming call, the left-hand field 178 will show the main options. To answer a call it is necessary to click on the switch 1 towards the left, and on completion of a call or rejection of a call it is necessary to click on the right-hand side of the switch. It will be appreciated that this tilting movement of the switch 1 will apply in all sliding positions of the switch 1, since all sliding position steps have the same option. After a call has been accepted, it will be possible to control volume using the right-hand switch 1′, as indicated by the reference numeral 179, for the incoming call. If it is desired to make the system quite simple and basic, it is of course possible to exclude the volume adjustment function, i.e., cause the right-hand and left-hand fields 178, 179 to be alike in this mode, i.e., like the left-hand field in FIG. 98. If the radio or CD is on with volume when a telephone call comes in, the sound associated with the radio or CD will automatically be muted and replaced by the sound connected with the telephone call, in a conventional known manner. The sound related to the radio or CD will return after the call has been ended, also in a conventional known manner.

It will be understood that the appearance of the dashboard as shown in the figures is by no means limiting for the system, the essential features being, of course, a representation of the use of switches and the provision of logical communication with the driver of the vehicle.

In the alternative shown in FIG. 99, the menu per se is presented in the same way as shown and described in connection with FIG. 98, but the driver of the vehicle will only see one of the four possible options in respectively the left-hand field and the right-hand field, i e., in connection with a incoming call The fields, which in FIG. 99 are indicated by the reference numerals 180 and 181 will successively show the different options when respective switches 1, 1′ are pushed up or down.

Although the previous figures have shown the use of a sliding switch that has three depression positions for each step position, it will be possible to use, for example, a four-point sliding switch in the vehicle, such as the mounting of switches 182 and 183 In this example, the screen image on the dashboard can resemble that shown in FIG. 102 and FIG. 103, and indicated by the reference numeral 184. However, it will be appreciated that the indicated option fields 185, 186 in FIG. 102 and 185, 187 in FIG. 103 can have a content other than that shown here in the form of an example

FIG. 101 shows quite clearly a sliding switch 188 with control element 109 which has four depression positions 190, 191, 192 and 193 for each of the possible step positions Y1, Y2, Y3, Y4 for the illustrated sliding switch. In FIG. 102 the adjustment of mirror option in the option field 185 has been selected, and the options for the adjustment of mirrors are displayed in the option field 106. In the illustrated example, the driver wishes to adjust the left-hand mirror, and by using the control element 189, the left-hand mirror can be adjusted upwards, downwards, or to one side or the other. In the other alternative shown in FIG. 103, the CD player option has been chosen in the option field 185, and in the option field 187 the position for playing CD tracks has been selected. The other options in the field 187 are standard options per se linked to, for example, CD players. FIGS. 104 and 105a-105d show an alternative solution where a sliding switch is mounted in connection with a centre console or arm rest for the driver of the vehicle. A switch solution of this kind could also be mounted for use by passengers for the control of functions not directly related to the driving of the vehicle, such as telephone, TV, windows, seats, etc. The switch, indicated here by the reference numeral 108, can be mounted in a module that can be drawn forward and out of the arm rest, as shown in steps in FIGS. 105a-105d The idea in this case is that the vehicle driver should be able to use this multifunction switch in a natural and comfortable working position. The switch will interact with a display screen that is naturally placed in or in close proximity to the vehicle dashboard. The system could also be used for projecting information onto the windscreen of the vehicle. The switch module will be designed to communicate with the display screen and the desired functions via a fixed current-carrying connection, optionally via a wireless connection, e.g., by using infrared beams or radio/bluetooth technology. Alternatively, the switch module 108 can be arranged to be withdrawn from the arm rest 109, optionally tilted upwards from the arm rest.

In FIGS. 106-109 a multifunction switch is indicated by the reference numeral 110 and mounted in a conventional way per se in the centre console in lieu of an ordinary automatic gear lever. The multifunction switch 110 has a control element 111 which is stepwise movable, as for the steps Y1, Y2, Y3, Y4 and Y5. The positions Y1− and Y5+ are so-called kick functions to be able to gear up or down quickly using the switch. The gear choices could be shown on a display 112 on the dashboard in the vehicle, as shown in FIG. 106. By using such a multifunction switch of the sliding switch type, it is possible not only to provide the various traditional switch positions known in connection with an automatic gear, but also to permit the choice of manual gearing by using the sliding and tilting possibilities found in a multifunction switch of this kind. Of course, it is also conceivable that a multifunction switch of this kind can be implemented in connection with an automatic gear lever.

1. An arrangement for a switch-equipped steering wheel in a vehicle, as for instance a car, where at least one switch is provided to control associated functions related to vehicle operation or vehicle accessories, characterised in
that the switch is a multifunction switch which is designed to carry out at least three separate switch functions, the multifunction switch elected from the group of:
a sliding switch equipped with a stepwise movable, tiltable and depressible control element, a tilting and/or depression of the control element and/or depression being adapted to actuate a respective switch function of at least three available separate switch functions at each step position of the control element, said step position of the control element being detectable;
a rotary switch equipped with stepwise rotational, tiltable and/or depressible control element, a tilting and/or depression of the control element at each rotary step position of the control element being adapted to actuate a respective switch function of at least three available separate switch functions at each step position of the control element, said step position of the control element being detectable;
a touch pad or touch screen having a plurality of touch sensitive fields which upon touch or depression are adapted to actuate a respective switch function, the touch pad or screen along one dimension providing at each of discrete steps at least three selectable fields being adapted to actuate a respective switch function, said step position of the control element being detectable;
that at least one display means associated with said multifunction switch, said display means elected from the group of: a dashboard mounted display and a drivers-field-of-visiob display on a vehicle windshield,
that the switch is connected to equipment for encoding or scanning the different switch positions or switch position combinations of the switch to emit related signals from the equipment;
that equipment is provided in the vehicle for decoding or analysing said signals and converting them into predetermined functions in the vehicle; and
that there is provided a common transmission path for transmitting the signals between the steering wheel and the vehicle's steering column or the vehicle's dashboard.

2. An arrangement as disclosed in claim 1, characterised in
that the switch housing is so designed that it is rotatable in a holder in the steering wheel in a reference plane that is essentially parallel to a surface of the switch and/or at an angle relative to the reference plane.

3. An arrangement as disclosed in claim 2, characterised in
that the holder is cup-shaped with a circle segment cross-section, where the segment spans an arc that is greater than 180°.

4. An arrangement as disclosed in claim 3, characterised in
that the housing or holder is made of a ferromagnetic material or has parts thereof made of such a material;
that the holder is cup-shaped with a circle-segment cross-section; and
that in the cup face of the holder or in the housing there is provided at least one magnet for securing the switch housing in the desired position.

5. An arrangement as disclosed in claim 1, characterised in
that the transmission path is only active within turns of a certain angle from the neutral position of the steering wheel.

6. An arrangement as disclosed in claim 1, characterised in
that the transmission path is active only for certain functions within turns of certain angle from the neutral position of the steering wheel, but active for other functions both within and outside the range of such turns.

7. An arrangement as disclosed in claim 1, 5 or 6, characterised in
that at least some of said signals are not transmittable via the transmission path when the speed of the vehicle exceeds a set limit, or when the vehicle reverses its normal forward motion direction.

8. An arrangement for a switch-equipped steering wheel in a vehicle, as for instance a car, where at least one function switch on either side of the steering wheel is provided to control associated functions related to vehicle operation or vehicle accessories, and where a first switch on one side of the steering wheel is assigned a first set of functions, whilst a second switch on the other side of the steering wheel is assigned a second set of functions, characterised in a change-over means which reconnects the first switch to be assigned to the second set of functions and the second switch to be assigned to the first set of functions when the steering wheel is turned in one direction or the other beyond the normal range of the steering wheel, so that the wheel enters an adjusted position range that is displaced by about 90°-270° relative to the normal position of the wheel.

9. is An arrangement as disclosed in claim 8, characterised in that to each switch there is assigned a first and a second function marker set of light-emitting or illuminable type, and that the first marker set is allocated to the first function set and the second function set is allocated to the second function set, that the first switch has the first marker set and the second switch has the second marker set activated when the steering wheel is in said normal range or part thereof, and that the change-over means is arranged to cause the second marker set to be activated on the first switch and the first marker set to be activated on the second switch when the wheel is in the adjusted position range or part thereof.

10. An arrangement as disclosed in claim 9, characterised in that the first and the second marker sets are arranged in layers on top of each other.

11. An arrangement as disclosed in claim 9, characterised in that the first and second marker sets are arranged side by side.

12. An arrangement as disclosed in claim 9, characterised in that the first and second marker sets are provided via LCD displays on the switch body.

13. An arrangement as disclosed in one or more of claims 8-12, characterised in that the control button of the switch is arranged to take up a normal position or last used function position when the wheel is turned within the adjusted range.

14. An arrangement as disclosed in claim 13, characterised in that the control or function button of the switch is electromagnetically actuatable to take up said position in the adjusted range.

15. An arrangement as disclosed in one or more of preceding claims 8-14, characterised in that the switches are located essentially diametrically relative to the centre axis of the steering wheel.

16. An arrangement as disclosed in one or more of preceding claims 8-15, characterised in that the switches are of a combined sliding and depression-operated type or combined sliding, tilting and depression operated type, said switches each being equipped with a stepwise movable, tiltable and depressible control element, tilting and/or depression of the control element and/or depression being adapted to actuate a respective switch function of at least three available separate switch functions at each step position of the control element, said step position of the control element being detectable.

17. An arrangement as disclosed in one or more of preceding claims 8-16, characterised in that the switch functions are displayed on a display on the vehicle's dashboard, and that the change-over means causes indication on the display switch function change-over caused by adjusted range when the steering wheel is outside its normal operational range.

18. An arrangement as disclosed in one or more of preceding claims 8-17, characterised in that the switches are inactive in the steering wheel turn ranges +/−60°-120° and +/−240°-300°.

19. An arrangement as disclosed in claim 18, characterised in that the switches are inactive in said steering wheel turn ranges when the speed of the vehicle exceeds a predetermined minimum speed.

20. An arrangement for a switch-equipped steering wheel in a vehicle, as for instance a car, where at least one function switch is arranged to control associated functions related to vehicle operation or vehicle accessories, characterised in
that the switch is a multifunction switch which is designed to carry out at least three separate switch functions, the multifunction switch elected from the group of:
a sliding switch equipped with a stepwise movable, tiltable and depressible control element, a tilting and/or depression of the control element and/or depression being adapted to actuate a respective switch function of at least three available separate switch functions at each step position of the control element, said step position of the control element being detectable;
a rotary switch equipped with stepwise rotational, tiltable and/or depressible control element, a tilting and/or depression of the control element at each rotary step position of the control element being adapted to actuate a respective switch function of at least three available separate switch functions at each step position of the control element, said step position of the control element being detectable;
a touch pad or touch screen having a plurality of touch sensitive fields which upon touch or depression are adapted to actuate a respective switch function, the touch pad or screen along one dimension providing at each of discrete steps at least three selectable fields being adapted to actuate a respective switch function, said step position of the control element being detectable;
that at least one display means associated with said multifunction switch, said display means elected from the group of: a dashboard mounted display and a drivers-field-of-visiob display on a vehicle windshield, and
that the switch has at least one switch housing that is attachable to a ring body of the steering wheel or to a connection between the ring body and the central area of the wheel.

21. An arrangement as disclosed in claim 20, characterised in that in the switch housing there is also a wireless transmitter that effects transmission of switch signals to a central processing unit located at a distance from the steering wheel.

22. An arrangement as disclosed in claim 21, characterised in that the wireless transmitter is based on bluetooth radio transmission.

23. An arrangement as disclosed in claim 20, 21 or 22, characterised in that the transmitter has equipment for coding or scanning the different switch positions or switch position combinations of the switch in order to transmit related signals to the central processing unit.

24. An arrangement as disclosed in one or more of claims 20-22, characterised in that the switch housing is so designed that it has a holder in which the switch is rotatable in a reference plane that is essentially parallel to a surface on the switch and/or at an angle to the reference plane.

25. An arrangement as disclosed in any one of previous claims 20-23, characterised in that in the housing there is provided at least one magnet for securing the switch body in the desired position.

26. An arrangement as disclosed in one or more of preceding claims 20-25, characterised in that the transmission path between the switch transmitter and the central processing unit is only active within turns of a certain angle relative to the neutral position of the steering wheel.

27. An arrangement as disclosed in one or more of preceding claims 24-30, characterised in that the central processing unit is especially adapted to form a connection between the transmitter in the switch and a mobile telephone that is installed in the vehicle.

28. An arrangement as disclosed in claims 20-26, characterised in that the central processing unit communicates with a display, for example of the LCD type, located on the vehicle's dashboard.

29. An interactive system for use of a switch device, mounted on the steering wheel of a vehicle, for example a car, where the switch device directly or indirectly is arranged to operate or control functions related to vehicle operation or vehicle accessories, characterised in
that the switch device consists of at least two multifunction switches mounted on opposite sides of the steering wheel relative to its centre; at least one of said multifunction switches elected from the group of:
a sliding switch equipped with a stepwise movable, tiltable and depressible control element, a tilting and/or depression of the control element and/or depression being adapted to actuate a respective switch function of at least three available separate switch functions at each step position of the control element, said step position of the control element being detectable;
a rotary switch equipped with stepwise rotational, tiltable and/or depressible control element, a tilting and/or depression of the control element at each rotary step position of the control element being adapted to actuate a respective switch function of at least three available separate switch functions at each step position of the control element, said step position of the control element being detectable;
a touch pad or touch screen having a plurality of touch sensitive fields which upon touch or depression are adapted to actuate a respective switch function, the touch pad or screen along one dimension providing at each of discrete steps at least three selectable fields being adapted to actuate a respective switch function, said step position of the control element being detectable;
that the vehicle has a display device, preferably on the dashboard of the vehicle, which a) on a first area thereof is designed to display available main functions and any sub-functions thereof, and where a first of the multifunction switches is arranged to effect on the manipulation thereof selection of a main function and/or sub-function; and b) on a second area thereof is designed to display available control operation options or function control options, and any sub-functions thereof, and where a second of the multifunction switches is arranged to cause on manipulation thereof the initiation of a selected control operation or function control, and/or subsidiary control operation thereof; and
that manipulation of the switches is represented by corresponding indications or markings on said first and second area respectively, so that a person can operate the switches by interactively observing said areas on the display device.

30. An interactive system for use of a switch device, mounted in a vehicle, e.g. a car, at a location elected from the group of: vehicle steering wheel, vehicle arm rest, vehicle centre console, a passenger section of the vehicle, where the switch device directly or indirectly is arranged to operate or control associated functions related to vehicle operation or vehicle accessories, characterised in
that the switch device consists of a multifunction switch mounted elected from the group of:
a sliding switch equipped with a stepwise movable, tiltable and depressible control element, a tilting and/or depression of the control element and/or depression being adapted to actuate a respective switch function of at least three available separate switch functions at each step position of the control element, said step position of the control element being detectable;
a rotary switch equipped with stepwise rotational, tiltable and/or depressible control element, a tilting and/or depression of the control element at each rotary step position of the control element being adapted to actuate a respective switch function of at least three available separate switch functions at each step position of the control element, said step position of the control element being detectable;
a touch pad or touch screen having a plurality of touch sensitive fields which upon touch or depression are adapted to actuate a respective switch function, the touch pad or screen along one dimension providing at each of discrete steps at least three selectable fields being adapted to actuate a respective switch function, said step position of the control element being detectable;
that the switch device communicates with a processor that converts switch manipulations into function selection and function control of related functions;
that the processor communicates with interface equipment in order to carry out said control of said related functions;
that the vehicle has a display device, a location of which elected from: vehicle dashboard and rear side of back rest of a vehicle seat, said display device on an area thereof being designed to display available functions, the multifunction switch being arranged on the manipulation thereof to effect selection of a function; and
that manipulation of the switches is represented by corresponding indications or markings on said area, to enable a system user to operate the switch by interactively observing said area on the display device.

31. An interactive system as disclosed in claim 29 or 30, characterised in that the switch device is arranged to control typical fast-action functions in the vehicle.

32. An interactive system as disclosed in claim 29, characterised in that the switch device consists of at least three multifunction switches, at least one of which being arranged to control typical fast-action functions in the vehicle.

33. An interactive system as disclosed in claim 29, 31 or 32, characterised in
that the display device has at least one additional area where selection of such fast-action function is indicated or marked.

34. An interactive system as disclosed in claim 29 or 30, characterised in
that said main functions are selected as one or more from the group consisting of:
constant speed setting (cruise control),
air and/or temperature setting,
sun roof manoeuvring,
adjustment of mirrors,
seat adjustment,
adjustment of steering wheel,
adjustment of on-board computer.

35. An interactive system as disclosed in claim 29 or 30, characterised in
that said optional functions are selected as one or more from the group consisting of:
telephoning,
operation of radio,
use of CD player,
use of GPS,
use of Internet
use of e-mail,
use of document processing.

36. An interactive system as disclosed in claim 29, 30, 31 or 32, characterised in
that said fast-action functions are selected as one or more from the group consisting of:
use of lights,
shifting between low beam and high beam,
use of direction indicators,
use of headlamp flasher,
use of windscreen wipers,
use of windscreen washer,
use of horn,
use of hazard warning lights,
control of gear shift.

37. An interactive system as disclosed in claim 29, where a sliding switch is used, characterised in
that the sliding switch is eccentrically mountable in a holder on the steering wheel;
that the sliding switch is rotatable and fixable relative to the holder; and
that the holder is rotatable and fixable relative to the steering wheel.

38. An interactive system as disclosed in claim 29 or 30, where a sliding switch is used, characterised in that the control element in at least one of the end positions is movable against the action of a spring a part of a step (so-called toggle operation) past this position to initiate a further function.

39. An interactive system as disclosed in claim 29, further comprising a means for allowing said at least two multifunction switches mounted on opposite sides of the steering wheel relative to its centre to exchange functions, so that the first switch takes over the functions of the second switch and vice versa when the wheel is turned from a normal position through an angle that is in the range 60°-120°, preferably 80°-90°.

40. An interactive system as disclosed in claim 29 or 39, further comprising a means for rendering said first and second multifunction switches inactive either when the steering wheel relative to its normal position moves through an angle range of 60°-120°, preferably 70°-110° or 80°-100°, or when the vehicle moves at a speed in excess of a fixed speed limit, for example selected in the range 20-60 km/hour.

41. An interactive system as disclosed in claim 29, characterised in that at least one of the multifunction switches is slidable and positionable along the ring body of the steering wheel or along the spokes of the wheel.

42. An interactive system as disclosed in claim 29, further comprising a means for allowing one of the multifunction switches to also take over the functions of one other of the multifunction switches if the last-mentioned sustains a functional failure.

43. An interactive system as disclosed in claim 39 and using a sliding switch, further comprising a means to move the control element of the sliding switch to a former position or a determined position when said first and second multifunction switches exchange function.
